(19) United States
(12) Patent Application Publication
(10) Pub. No.: US 2014/0326711 A1
(43) Pub. Date: Nov. 6, 2014

(54) DEVICES AND METHODS FOR HEAT GENERATION

(71) Applicant: Industrial Heat, Inc., Raleigh, NC (US)

(72) Inventor: Andrea Rossi, Miami Beach, FL (US)

(73) Assignee: LEONARDO CORPORATION, Miami Beach, FL (US)

(21) Appl. No.: 14/262,740

(22) Filed: Apr. 26, 2014

Related U.S. Application Data
(60) Provisional application No. 61/818,553, filed on May 2, 2013.
(60) Provisional application No. 61/819,058, filed on May 3, 2013.
(60) Provisional application No. 61/821,914, filed on May 10, 2013.

(51) Int. Cl. H05B 1/02; G21B 3/00

(52) U.S. Cl. CPC H05B 1/023; G21B 3/002
USPC 219/439

(57) ABSTRACT

A reactor device includes a sealed vessel defining an interior, a fuel material within the interior of the vessel, and a heating element proximal the vessel. The fuel material may be a solid including nickel and hydrogen. The sealed vessel may be sealed against gas ingress or egress and may contain no more than a trace amount of gaseous hydrogen. The sealed vessel is heated with an input amount of energy without ingress or egress of material into or out of the sealed vessel. An output amount of thermal energy exceeding the input amount of energy is received from the sealed vessel. The fuel material has a specific energy greater than that of any chemical reaction based energy source.

### CROSS-REFERENCE TO RELATED APPLICATION

This application claims the benefit of priority of U.S. provisional patent application No. 61/818,553, titled “HEAT ENERGY PRODUCTION DEVICE AND RELATED METHODS,” filed on May 2, 2013, which is incorporated herein in its entirety by this reference. This application also claims the benefit of priority of U.S. provisional patent application No. 61/819,058, titled “EXEMPLARY DEVICES AND METHODS FOR GENERATING HEAT,” filed on May 3, 2013, which is incorporated herein in its entirety by this reference. This application furthermore claims the benefit of priority of U.S. provisional patent application No. 61/821,914, titled “NOVEL METHODS AND DEVICES FOR USE IN GENERATING USEFUL HEAT,” filed on May 10, 2013, which is incorporated herein in its entirety by this reference.

### TECHNICAL FIELD

The present disclosure relates to the release of thermal energy reliably and abundantly from compact fuel sources. More particularly, the present disclosure relates to heat reactor devices and methods in which exothermic reactions are triggered by heat input in combination with a fuel.

### BACKGROUND

Despite the ongoing worldwide public debate as to whether human activity is triggering climate change on a global scale, relief from dependence on fossil fuels and their obvious polluting effects would be of great benefit. Burning fossil fuels essentially inevitably releases carbon dioxide and carbon monoxide at least to some extent and creates sovereign interdependencies that are in some cases unwanted. Thus, the pursuit of energy sources beyond fossil fuels has long been of interest to man.

Many alternative energy sources are under ongoing consideration. These include solar energy, wind energy, tidal energy and others. Such pursuits do foster enthusiasm from the well-intending conservationists. Solar energy panels and wind energy devices are now appearing, but typically in either small scale settings with unreliable results, or in large scale facilities that must be selectively located for reliability, which constraint limits their ultimate success toward serving large, varied, and widely distributed populations. It may not be entirely appreciated that dependence on reliable and plentiful energy casts doubt as to whether any energy sources that vary with weather conditions and seasonal effects can ultimately address needs at community and industrial levels.

Nuclear energy has found some degree of success, particularly in serving European communities. However, recent events, particularly in Japan, have reminded us all that current nuclear fission technologies have considerable environmental harm capabilities. Radioactive waste materials from typical fission reactors remain dangerously active for many years, with consequent great risks for persons living near stored radioactive wastes. Safe operation of the facilities is also a concern, with several well-known disasters still swaying public fears.

Heat production in pressurized vessels containing metals and gaseous hydrogen has been previously reported. In particular, significant research has pursued nickel and hydrogen exothermal reactions in high gaseous hydrogen pressure environments. The disclosure herein addresses applications where thermal input combined with a fuel input produces a usable heat output that has many applications.

### SUMMARY

This Summary is provided to introduce in a simplified form concepts that are further described in the following detailed descriptions. This Summary is not intended to identify key features or essential features of the claimed subject matter, nor is it to be construed as limiting the scope of the claimed subject matter.

According to at least one embodiment, a reactor device includes a sealed vessel defining an interior, a fuel material within the interior of the vessel, and a heating element proximal the vessel. The fuel material includes a solid comprising nickel and hydrogen.

In at least one example, the sealed vessel contains no more than a trace amount of gaseous hydrogen. The sealed vessel is sealed against gas ingress or egress.

In at least one example, a first ceramic shell is between the sealed vessel and the heating element, and a second ceramic shell surrounds the first ceramic shell and the heating element.

The sealed vessel may consist of steel. In at least one example, the sealed vessel includes a steel tube having two ends sealed by steel caps.

In at least one example, the interior of the sealed vessel is cylindrical, and the fuel material is uniformly distributed within the interior of the sealed vessel.

In at least one example, the heating element surrounds the sealed vessel.

In at least one example, a first ceramic shell surrounding the sealed vessel is surrounded by the heating element, and a second ceramic shell surrounds the heating element.

The heating element may include a resistor coil assembly.

In at least one embodiment, a method includes providing a sealed vessel, heating the sealed vessel with an input amount of energy without ingress or egress of material into or out of the sealed vessel; and receiving from the sealed vessel an output amount of thermal energy exceeding the input amount of energy.

In at least one example, heating the sealed vessel includes heating the sealed vessel from outside the sealed vessel.

In at least one example, a ratio defined by dividing the output amount of thermal energy by the input amount of energy exceeds 5.0.

In at least one example, heating the sealed vessel entails initiating a reaction within the vessel of a fuel material having a specific energy greater than 1×10⁵ watt×hour/kg.

In at least one example, heating the sealed vessel includes initiating a reaction within the vessel of a fuel material having a specific energy greater than that of any chemical reaction based energy source.

Heating the sealed vessel may entail alternating a heating element between on and off states. In east least one example, alternating a heating element between on and off states is achieved by periodically providing electrical current to a resistor coil assembly.

In at least one example, the sealed vessel contains a solid fuel material and no more than a trace amount of gaseous hydrogen. The solid fuel material may include nickel and hydrogen.

In one or more embodiments, a system for converting thermal input and fuel into a heat output is provided. The system includes a device that includes a sealed vessel defining an interior, a heating element proximal the vessel and being selectively activatable to provide heat to the sealed vessel, and a fuel material within the interior of the vessel that comprises a solid including nickel and hydrogen. The interior of the sealed vessel is not preloaded with a pressurized gas when in an initial operating state before activation of the heating element. The system further includes a temperature measuring gauge in communication with the device and configured for monitoring the temperature thereof and a controller in communication with the heating element and the temperature measuring gauge. The controller is configured to activate the heating element in response to measurements from the temperature measuring gauge.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a longitudinal cross-sectional view of a reactor device according to at least one embodiment.

FIG. 2 is transverse cross-sectional view of the reactor device of FIG. 1.

FIG. 3A is a thermal image collected on the reactor device of FIG. 1.

FIG. 3B is an X profile plot collected from the image of FIG. 3A.

FIG. 3C is a Y profile plot collected from the image of FIG. 3A.

FIG. 4 is a longitudinal cross-sectional view of a reactor device according to another embodiment.

FIG. 5 is a transverse cross-sectional view of the reactor device of FIG. 4.

FIG. 6 is an end view of the reactor device of FIG. 4.

FIG. 7 is a diagrammatic representation of an experimental set-up by which the reactor device of FIG. 4 was evaluated.

FIG. 8 is a plot of radiative thermal power versus time according to measurements taken of the reactor device of FIG. 4.

FIG. 9 is a plot of radiative and total energy produced as a function of electrical energy consumed according to measurements taken of the reactor device of FIG. 4.

FIG. 10 is a Ragone chart showing peak power per mass and specific energy per mass of various chemical energy sources.

FIG. 11 is a longitudinal cross-sectional view of a reactor device according to yet another embodiment.

FIG. 12 is transverse cross-sectional view of the reactor device of FIG. 11.

FIG. 13 is a diagrammatic representation of an experimental set-up by which the reactor device of FIG. 11 was evaluated.

FIG. 14 is a plot of the average temperature versus time according to measurements taken of the reactor device of FIG. 11.

FIG. 15 is a plot of power produced over time, and power consumed during the same time, according to measurements taken of the reactor device of FIG. 11.

FIG. 16 is a plot of the ratio between energy produced and energy consumed by the reactor device of FIG. 11, together with a step-function plot of power consumption normalized to 1.

FIG. 17 is a diagrammatic representation of a system for producing heat, according to at least one embodiment.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

### Reactor Device 100 and First Experimental Results

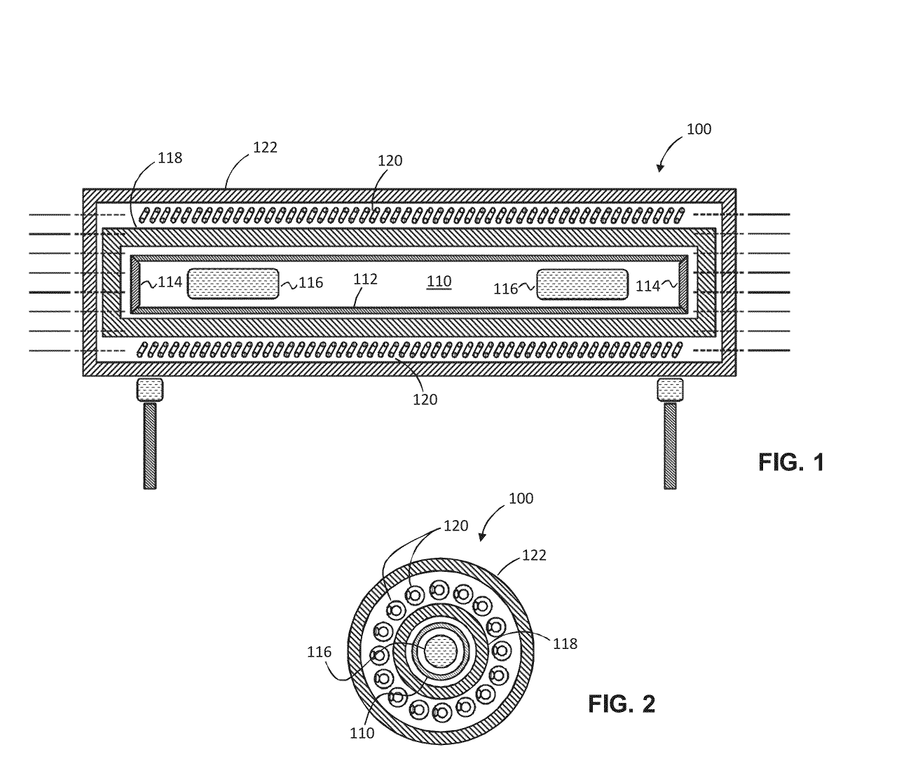

A layered tubular reactor device 100, as represented diagrammatically in cross-sectional view in FIG. 1, was used in the first of three experiments. The cross-sectional view of FIG. 1 is taken in a plane in which the central longitudinal axis of the layered tubular device 100 extends. A sealed steel inner tube 110 included a cylindrical wall 112 that extended between two end caps 114. The inner tube 110 contained reaction charges 116 in two distinct longitudinal locations. As will be described later, reaction charges were more widely and uniformly distributed in the two other experiments. In this first experiment, a first cylindrical ceramic shell layer 118 surrounded the inner tube 110. Each of sixteen resistor coils 120 extended the length of the interior of the reactor device 100 between the first cylindrical ceramic shell layer 118 and a more outer second cylindrical ceramic shell layer 122. As shown in FIG. 2, the coils 120 were circumferentially distributed around the first cylindrical ceramic shell layer 118 to produce uniformly distributed heating when electrical current was passed through the coils. The cross-sectional view of FIG. 2 is taken in a plane perpendicular to the central longitudinal axis of the layered tubular device. The coils were operated continuously at about one kilowatt and thermal images were taken periodically of the exterior of the reactor device 100.

Experimental investigations of heat production in layered tubular reactor devices according to several embodiments have been conducted. In each example, the reactor device was charged with a small amount of hydrogen loaded nickel powder. An exothermic reaction was initiated by heat from resistor coils inside the reactor device. Measurement of the produced heat was performed with high-resolution thermal-imaging cameras, recording data every second from the hot reactor device. Electrical power input was measured with a large bandwidth three-phase power analyzer. While all three experiments yielded interesting results, the reactor device 100 was damaged during the first of the three experiments. The latter two experiments were conducted without equipment failure, and data was collected in the latter two experimental runs for durations lasting 96 and 116 hours, respectively. Heat production was indicated in both experiments. The 116-hour experiment also included a calibration of the experimental set-up without an active charge present in a dummy tubular reactor device. In the case of the dummy reactor device, no extra heat was generated beyond the expected heat from the electrical input.

Computed volumetric and gravimetric energy densities for the 96-hour and 116-hour experiments were found to be far above those of any known chemical source. Even by the most conservative assumptions as to the errors in the measurements, the results are still at least an order of magnitude greater than conventional chemical energy sources. As such, the reactor devices described herein can produce much more energy per unit weight of fuel than can be obtained from known chemical processes.

The reactor devices illustrated in the drawings and detailed here can be described as energy catalyzer HT reactor devices, where HT stands for high temperature. In a reactor device disclosed herein, an exothermic reaction is fueled by a mixture of nickel, hydrogen, and a catalyst. In the embodiments detailed in these descriptions, thermal energy is produced after the reaction within an inner-most tube of a layered tubular reactor device is activated by heat produced by a set of resistor coils located outside the inner-most tube but inside the layered tubular reactor device. Once operating temperature is reached, it is possible to control the reaction by regulating the power to the coils. These descriptions relate to testing of the reactor devices disclosed herein under controlled conditions and with high precision instrumentation. Measurements were performed with high accuracy and reliability, such that excess heat production beyond any previously known chemical process has been established.

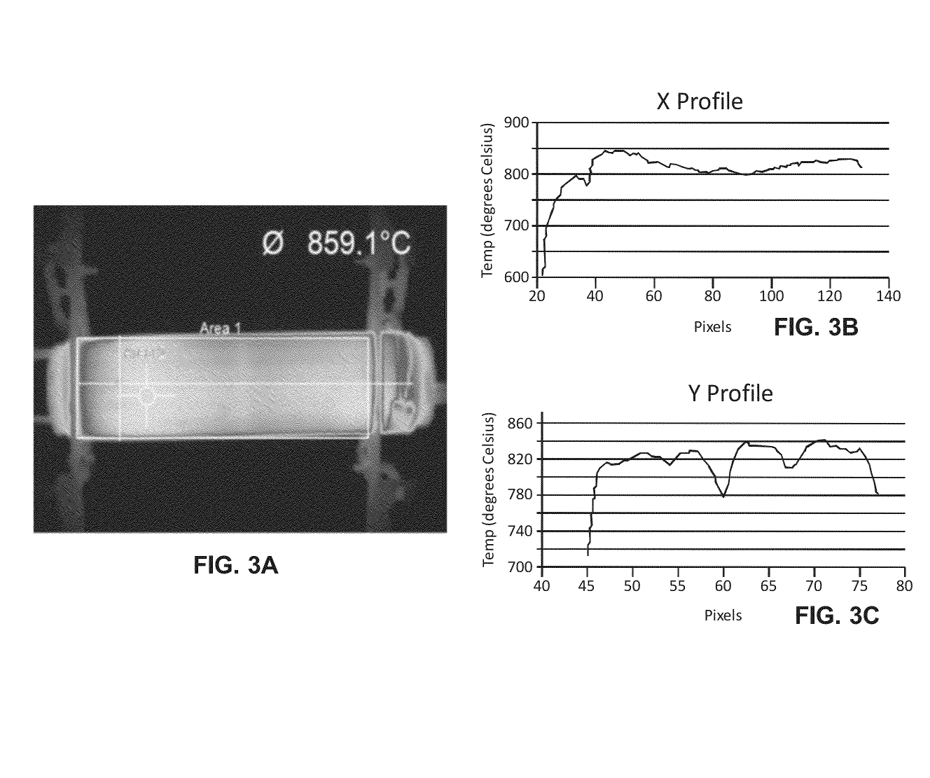

Displays of the thermal data taken in the first experiment are provided in FIGS. 3A-3C. An Optris IR thermographic camera monitored surface temperatures of the exterior of the layered tubular reactor device 100. A laptop computer captured data from the thermographic camera. The thermal data yielded results of approximately 860 degrees Celsius in the hottest areas. FIG. 3A is a thermal image. The indicated temperature of 859 degrees Celsius refers to the area within the circle of the cross hair mark. Graphs in FIGS. 3B and 3C show the temperature distribution monitored along the two visible lines in the image: the X profile plot in FIG. 3B refers to the horizontal line traversing the whole device; and the Y profile plot in FIG. 3C shows the temperature along the vertical line located on the left side of the thermal image of FIG. 3A.

The reactor device 100 was damaged during the first of the three experiments before complete calorimetry data was collected. The steel cylinder 110 containing the active charge overheated and melted. However, the temperature distributions in FIGS. 3B and 3C, particularly the Y profile in FIG. 3C, demonstrate some interesting conclusions. If one relates the length of the vertical line (32 pixels) at which the Y profile was taken to the diameter of the device (11 cm), one may infer that each pixel in the image corresponds to a length of approximately 0.34 cm on the device, with some approximation, due to the fact that the thermal image of FIG. 3A is a two-dimensional projection of a cylindrical object, reactor device 100. The thermal image shows a series of stripe-like, darker horizontal lines, which are confirmed by the five temperature dips in the Y profile. This means that, in the device image, a darker line appears every 6.4 pixels approximately, corresponding to 2.2 cm on the device itself. As described with reference to FIGS. 1 and 2, sixteen resistor coils 120 are set horizontally, parallel to and equidistant from the cylinder axis, and extending throughout the whole length of the device. By comparing the distance between darker stripes and the distance between coils, one may reach the conclusion that the lower temperatures picked up by the thermal camera nicely match the areas overlying the resistor coils. In other words, the temperature dips visible in the diagram are actually shadows of the resistor coils, projected outward by a source of thermal energy located further inside the device, and of higher intensity as compared to the energy emitted by the coils themselves. This is evidence of an exothermic reaction that occurred within the inner tube 110.

### Reactor Device 200 and Second Experimental Results

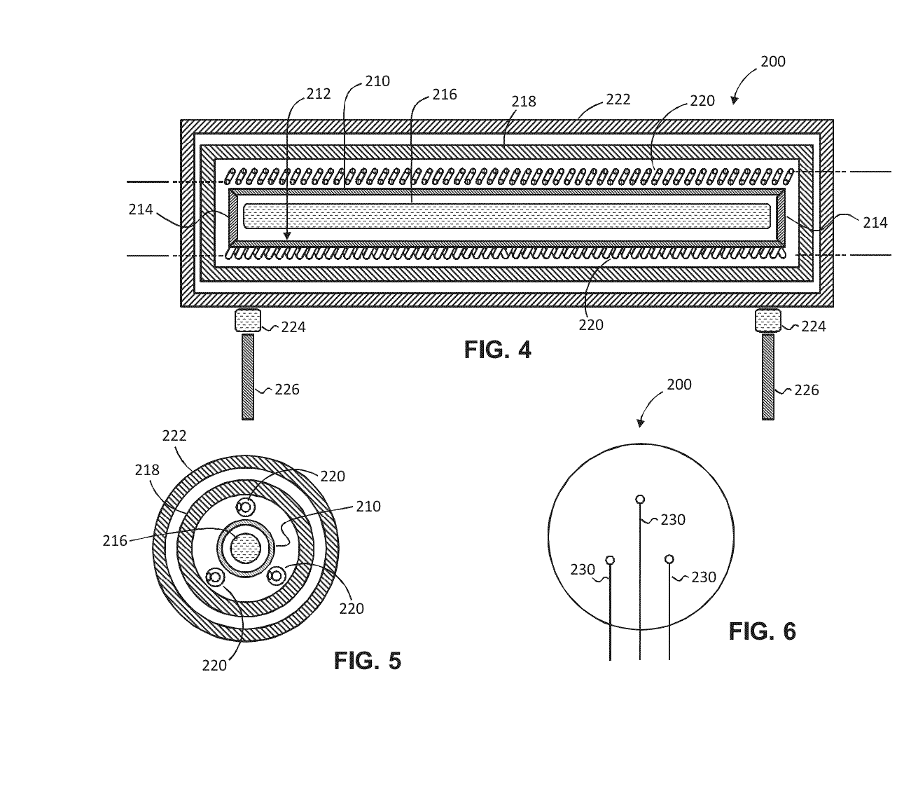

A layered tubular reactor device 200, as represented diagrammatically in cross-sectional view in FIG. 4, was used in the second of three experiments described herein. The cross-sectional view of FIG. 4 is taken in a plane in which the central longitudinal axis of the layered tubular device 200 extends. The cross-sectional view of FIG. 5 is taken in a plane perpendicular to the central longitudinal axis of the layered tubular device. The reactor device 200 in this experiment was a layered cylindrical device having an inner tube 210. The inner tube 210 had a 3 millimeter thick cylindrical wall 212 with a 33 millimeter diameter. The cylindrical wall 212 of the inner tube 210 was constructed of AISI-310 steel. Cone-shaped end caps 214 constructed of AISI-316 steel were hot-hammered into the longitudinal ends of the inner tube 210, sealing it hermetically. Cap adherence was obtained by exploiting the higher thermal expansion coefficient of AISI-316 steel (caps 214) with respect to AISI-310 steel. As such the inner tube 210 constitutes a vessel sealed against ingress or egress of matter, including gaseous hydrogen and other fluids. This represents a distinction of the reactor device 200 over previous reaction vessels that were preloaded with pressured gases such as hydrogen.

The inner tube 210 contained a powder reaction charge 216 uniformly distributed along the axis of the device. A silicon nitride cylindrical ceramic outer shell 222 was 33 centimeters in length and 10 centimeters in diameter. A cylindrical inner shell 218, which was made of a different ceramic material (corundum) was located within the outer shell 222. The inner shell 218 housed three delta-connected spiral-wire resistor coils 220, which were laid out horizontally, parallel to and equidistant from the center axis of the device. The three resistor coils 220 were independently wired to a power supply by wires 230 that extended outward from the reactor device 200 as shown in FIG. 6. The resistor coils 220 essentially ran the interior length of the device. The outermost shell 222 was coated with an aeronautical-industry grade black paint, which is capable of withstanding temperatures up to 1200 degrees Celsius.

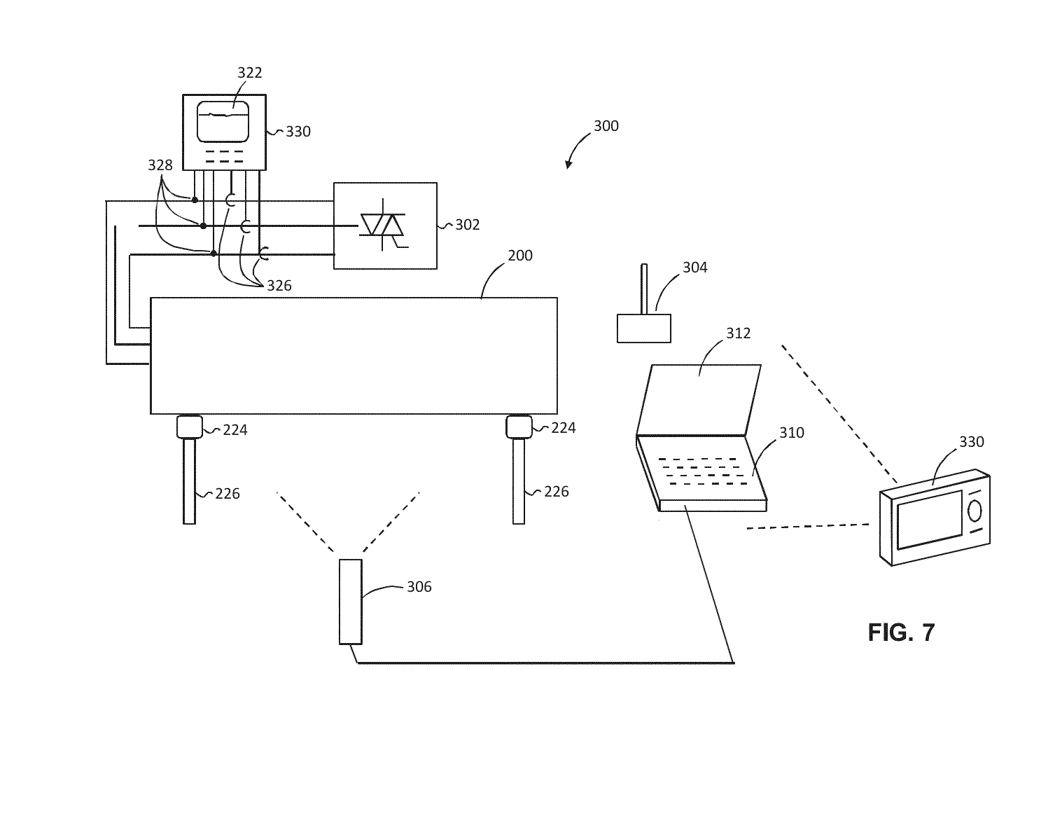

The experimental set-up 300 of the second experiment is diagrammatically represented in FIG. 7. The resistor coils within the reactor device 200 were fed by a TRIAC power regulator device 302 which interrupted each phase periodically, in order to modulate power input with a controlled waveform. This procedure, needed to properly activate the reaction charge 216 (FIG. 4), had no bearing on the power consumption of the device, which remained constant throughout the experiment. In consideration of the results of the first experiment, in which the reactor device 100 was damaged, the power input to the reactor device 200 was limited to 360 Watts.

Weighing operations were performed on another similar device present at the location of the second experiment. The cap-sealed inner tube 210 containing the active charge was compared to another identical cylinder, empty and without caps. The difference in weight obtained was 0.236 kilograms. This is therefore assigned to the charge loaded into the inner tube 210 and to the weight (not subtracted in the present test) of the two metal caps. In the course of the experiment, the reactor device 200 was placed on a metal frame and allowed to freely radiate to the surrounding air. The device 200 floated on two contact points insulated by fiberglass insulation material 224. The frame supporting the device 200, as represented by two struts 226 in FIG. 7, was reduced to the minimum structure necessary for mechanical stability. The temperature of the area of the experiment was constantly measured by a heat probe 304, and averaged 15.7 degrees Celsius (289 degrees Kelvin).

The instruments used to acquire experimental data were at all times active for the entire 96 hours of the second experiment. An IR thermography camera 306 was used to measure the surface temperature of the reactor device 200. A wide band-pass power quality monitor 320 measuring the electrical quantities on each of the three phases was used to record the power absorbed by the resistor coils 220 (FIGS. 4-5).

The thermal camera 306 used was an Optris PI 160 Thermal Imager with a 30 degree by 23 degree lens, and UFPA 160 by 120 pixel sensors. The camera spectral interval is from 7.5 to 13 micrometers, with a precision of 2 percent of measured value. The thermal camera 306 was positioned about 70 centimeters below the reactor device 200, with the lens facing the lower half of the exterior of the device. All thermal imaging in this second experiment was thus taken from below the reactor device 200 in order not to damage the thermal camera 306 from the heat transferred by rising convective air currents. This choice, however, had a negative impact on the measurements: the presence of the two metal props on the stationary image shot by the thermal camera 306 introduced a degree of uncertainty in the measurements, as will be explained in detail below. The thermal camera capture rate was set at 1 Hz, and the thermal data was acquired by a computing device, which was a laptop computer 310. A thermal image was visualized on the display 312 of the computer 310, which was open for analysis throughout the course of the experiment.

Electrical measurements were performed by a power monitor 320: a PCE-830 Power and Harmonics Analyzer 320 by PCE Instruments with a nominal accuracy of 1%. This instrument continuously monitored, on an LCD display 322, the values of instantaneous electrical power (active, reactive, and apparent) supplied to the resistor coils, as well as energy consumption expressed in kWh. Of these parameters, the latter one, energy consumed, was of interest for the purposes of the test, which was designed to evaluate the ratio of thermal energy produced by the reactor device to electrical power consumption for the number of hours subject to evaluation. The power monitor 320 was connected directly to the reactor device resistor coil power cables 230 (FIG. 6) by three clamp ammeters 326, and three probes 328 for voltage measurement. A timepiece was placed next to the power monitor 320, and a video camera 330 was set up on a tripod and focused on the timepiece and power monitor. At one frame per second, the entire second experiment was filmed and recorded for the 96-hour duration of the experiment.

Instruments necessary for detecting possible radioactive emissions were also placed in the vicinity of the reactor device. Radiological measurements, essential for safety certification of the device 200 and experimental conditions, were performed by a qualified person. A radiological report of the methods and results of these measurements was prepared. In the experiments, it was decided to use two different wide-spectrum and high-sensitivity photon detectors: the first detector was chosen for the purpose of measuring in the spatial surroundings any rate variation of ambient dose equivalent H*(10), and the second detector was chosen for measuring and recording CPM (counts per minute) rate variations in a specific position. With respect to instrumental and ambient background, the measurements performed did not reveal significant differences either in H*(10) or CPM ascribable to the prototype.

Regarding data analysis, upon conclusion of the second experiment, the recordings from the video camera were examined. By reading the images reproducing the PCE-830's LCD (power monitor 320) display at regular intervals, it was possible to make a note of the energy (kWh) absorbed by the resistor coils. Subsequently, the average hourly power consumption of the reactor device 200 was calculated and determined to be 360 watts.

As far as the evaluation of the energy produced by the device disclosed herein is concerned, two dominant components must be taken into account, the first being emission by thermal radiation, the second the dispersion of heat to the environment by convection. Heat transfer by conduction was deemed to be negligible, due to the minimal surface of contact (not more than a few millimeters squared) between the device and its supports, and to the fiberglass insulation material placed at the contact points. This material, however, partially obscured the image of the surface of the device from view by the thermal camera.

Energy emitted by radiation was calculated by Stefan-Boltzmann's formula, which allows one to evaluate the heat emitted by a body when the surface temperature is known. Surface temperature was measured by analyzing the images acquired by the thermal camera, after dividing the images into multiple areas, and extracting the average temperature value associated to each area. Conservatively, surface emissivity during measurements was set to 1.

The calculation of energy loss by convection from objects of cylindrical shape placed in air has been presented many times in academic papers that address issues related to heat transfer. It was therefore possible to estimate the amount of heat transferred by the reactor device 200 to the surrounding air in the course of the second experiment. The thermal performance of the reactor device 200 was finally obtained as the ratio between the total energy emitted by the device and the energy consumed by its resistor coils.

Regarding the calculation of power emitted by radiation, Planck's Law expresses how the monochromatic emissive power of a black body varies as a function of its absolute temperature and wavelength. Integrating over the whole spectrum of frequencies, one obtains the total emissive power (per unit area) of a black body, through what is known as Stefan-Boltzmann's Law:

M=σT⁴ [W/m²] (Equation 1)

where sigma (σ) indicates Stefan-Boltzmann's constant, equal to 5.67×10⁻⁸ [W/m²K⁴].

In the case of real surfaces, one must also take emissivity (ε) into account. Emissivity (epsilon, ε) expresses the ratio between the energy emitted from the real surface, and that which would be emitted by a black body having the same temperature. The formula then becomes:

M=εσT⁴ [W/m²] (Equation 2)

where emissivity (ε) may vary between 0 and 1, the latter value being the one assumed for a black body. As it was not possible to measure the emissivity of the coating used in this analysis, it was decided to conservatively assume a value of ε=1, thereby considering the reactor device 200 as equivalent to a black body. This value was then input in the thermal imagery software, which allows the user to modify some of the parameters, such as ambient temperature and emissivity, even after having completed the recordings. The software then uses the new settings to recalculate the temperature values assigned to the recorded images. It was therefore possible to determine the emitted thermal power of the reactor device on the basis of surface temperature values that were never overestimated with respect to actual ones.

That temperature values were never overestimated may be demonstrated by an example in which one assigns a value lower than 1 to emissivity (ε). A thermal image of the reactor device was divided into 40 areas. Emissivity was set to 1 everywhere, except in two areas, where it was set to 0.8 and 0.95, respectively. The temperature which the IR camera assigned to the two areas was 564.1° C. and 511.7° C., respectively. These values are much higher than those of the adjacent areas. It is therefore clear that by assigning a value of 1 to emissivity (ε) to every area, a conservative measurement is indeed performed. If the lower values for emissivity (ε) were extended to all areas, this would lead to a higher estimate of irradiated energy density. For these calculations, therefore, in view of the fact that a conclusive value of emissivity (ε) could be assigned, it was desirable to avoid any arbitrary source of overestimation and so emissivity (ε) was set to 1 in all areas.

A thermal camera does not measure an object's temperature directly: with the help of input optics, radiation emitted from the object is focused onto an infrared detector which generates a corresponding electrical signal. Digital signal processing then transforms the signal into an output value proportional to the object temperature. Finally, the temperature result is shown on the camera display. The camera software derives the temperature of objects by an algorithm which takes several parameters and corrective factors into account, e.g. user settings for emissivity and detector temperature, taken automatically by a sensor on the lower part of the camera itself.

Moreover, every Optris camera-and-optics set has its own calibration file supplied by the manufacturer. The image provided by the thermal camera, according to the placement of the camera in the second experiment, shows only the lower part of the reactor device. The same temperatures measured there were held good for the upper half of the device as well, and were used for subsequent calculations. Convection has a different effect on the top of an object compared to the bottom. Therefore, the temperature values according to the set-up of the second experiment should be those least affected by convective dispersion. This choice, however, leads to a heavy penalty in the calculation of the average surface temperature of the reactor device. In fact, in the thermal images associated with the setup, the shadows of the two supportive metal struts, and of the insulating materials placed under the device, are clearly visible. These effects negatively distort the calculation of the surface temperature and prevent a complete view of the underlying emitting surfaces.

To overcome this effect, it was decided to divide the entire image of the thermal camera into a progressively greater number of areas, for which average temperature values for the entire duration (96 hours) of the second experiment were calculated. Subsequently, these values were raised to the fourth power, and then averaged together to obtain a single value to be assigned to the reactor device. By this approximation, the blacked-out areas are actually considered as pertaining to the surface of the device, thereby underestimating the energy emitted. It was decided to proceed in this manner in order to obtain a lower limit for emitted energy based solely on collected data, without making arbitrary assumptions that might have led to errors by overestimation.

The thermal image obtained from the thermal camera covered an area of 160 by 41 pixels and was progressively divided into 10, 20 and 40 areas, following the following criterion: in the first case, 10 areas of 16 by 41 pixels; in the second, 20 areas of 8 by 41 pixels; finally, in the third, 40 areas of 4 by 41 pixels.

For each area, as well as for the entire duration of the video footage, a time diagram of the average temperature trend was extracted; data was then saved to Excel worksheets, from which the averages were extracted. The temperatures thus obtained, expressed in Kelvin for each area, are presented in the following three tables.

Table I provides temperature values associated with division into 10 areas. By averaging these 10 values, one obtains a temperature, associable to the reactor device 200, of 709 degrees Kelvin.

TABLE I

| Area 1 | Area 2 | Area 3 | Area 4 | Area 5 | Area 6 | Area 7 | Area 8 | Area 9 | Area 10 |
|---|---|---|---|---|---|---|---|---|---|
| 628.8 K | 623.8 K | 665.1 K | 754.3 K | 759.3 K | 761.8 K | 761.2 K | 759.0 K | 756.4 K | 624.8 K |

Table II provides temperature values associated with division into 20 areas By averaging these 20 values, one obtains an assignable temperature for the reactor device 200, of 710.7 degrees Kelvin.

TABLE II

| Area 1 | Area 2 | Area 3 | Area 4 | Area 5 | Area 6 | Area 7 | Area 8 | Area 9 | Area 10 |
|---|---|---|---|---|---|---|---|---|---|
| 660.9 K | 596.4 K | 599.0 K | 738.9 K | 757.0 K | 757.9 K | 760.1 K | 761.1 K | 762.0 K | 763.0 K |
| Area 11 | Area 12 | Area 13 | Area 14 | Area 15 | Area 16 | Area 17 | Area 18 | Area 19 | Area 20 |
| 762.7 K | 761.3 K | 760.5 K | 760.0 K | 758.7 K | 757.3 K | 732.0 K | 521.8 K | 650.5 K | 592.8 K |

Table III provides temperature values associated with division into 40 areas by averaging these 40 values, one obtains an assignable temperature for the reactor device 200, of 711.5 degrees Kelvin.

TABLE III

| Area 1 | Area 2 | Area 3 | Area 4 | Area 5 | Area 6 | Area 7 | Area 8 | Area 9 | Area 10 |
|---|---|---|---|---|---|---|---|---|---|
| 641.6 K | 670.7 K | 644.5 K | 546.0 K | 535.3 K | 667.4 K | 724.0 K | 758.4 K | 758.8 K | 757.9 K |
| Area 11 | Area 12 | Area 13 | Area 14 | Area 15 | Area 16 | Area 17 | Area 18 | Area 19 | Area 20 |
| 758.5 K | 759.7 K | 761.1 K | 762.0 K | 762.4 K | 762.9 K | 763.4 K | 763.6 K | 764.5 K | 764.9 K |
| Area 21 | Area 22 | Area 23 | Area 24 | Area 25 | Area 26 | Area 27 | Area 28 | Area 29 | Area 30 |
| 764.7 K | 764.5 K | 763.6 K | 763.0 K | 762.9 K | 762.5 K | 762.0 K | 761.3 K | 760.7 K | 760.9 K |
| Area 31 | Area 32 | Area 33 | Area 34 | Area 35 | Area 36 | Area 37 | Area 38 | Area 39 | Area 40 |
| 760.7 K | 758.6 K | 753.3 K | 713.2 K | 581.4 K | 463.5 K | 652.2 K | 652.6 K | 608.1 K | 564.4 K |

The comparison between the different subdivisions into areas shows that the average temperature depends only slightly upon the choice of subdivision, and actually tends to increase, because the areas near the blacked-out ones are treated more effectively. With reference to the third case above, one may calculate thermal power emitted by the reactor device 200 by first considering the average of the fourth power of the temperature of each area. One gets the following value:

(T⁴)_{average}=2.74×10¹¹ [K⁴] (Equation 3)

Emitted thermal power (E) may be obtained by multiplying the Stefan-Boltzmann formula by area of the reactor device:

Area=2πRL=1036×10⁻⁴ [m²] (Equation 4)
where:
R=radius of the reactor device 200, equal to 0.05 [m]
L=length of the reactor device 200, equal to 0.33 [m]
Emitted thermal power (E) may be obtained using the above values comes to:

E=(5.67×10⁻⁸)(2.74×10¹¹)(1036×10⁻⁴)=1609 [W] (Equation 5)

In calculating the total area of the reactor device 200 of the second experiment, the area of the two bases was omitted, their surface being:

Area Bases=2(πR²)=157×10⁻⁴[m²] (Equation 6)

This choice was motivated by the fact that for these parts of the cylinder, which are not framed by the IR camera, any estimate of irradiated energy would have been highly conjectural. This factor was not included in calculating E, thereby underestimating radiative thermal power emitted by the reactor device.

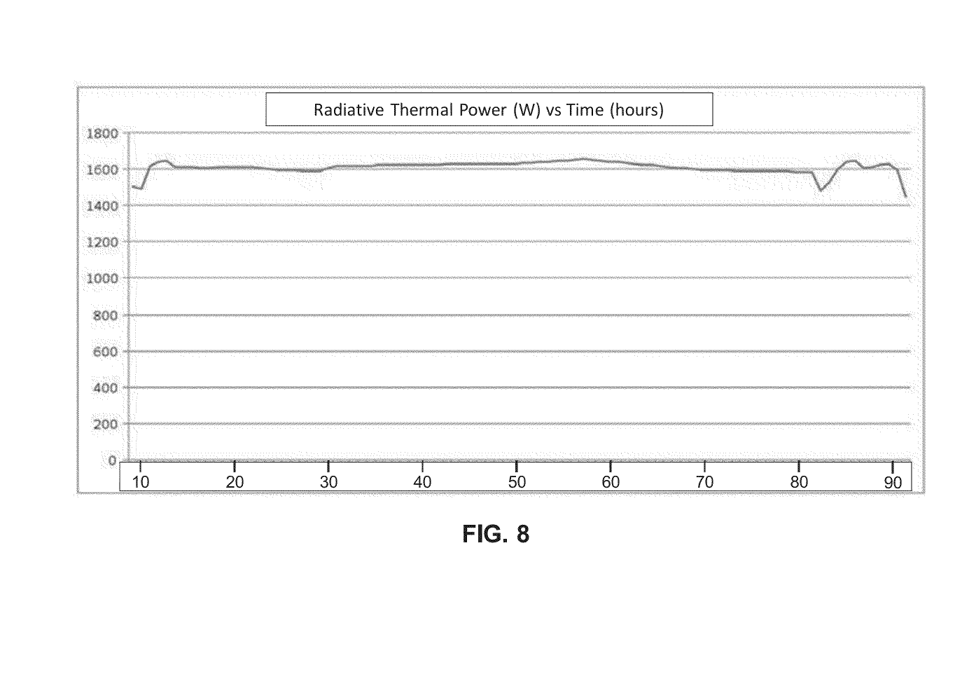

Emitted thermal power (E), apart from minute variations, remained constant throughout the measurement, as may be seen in FIG. 8, which is a plot of the measured radiative power versus time in hours. Power production is almost constant with an average of 1609.4 W. To this power, the thermal power is subtracted due to the temperature of the room, which had an average of 15.7 degrees Celsius over 96 hours, as follows to reach a final value of approximately 1568 watts.

E(room)=(5.67×10⁻⁸)(289)⁴(1036×10⁻⁴)=41 [W] (Equation 7)

E−E(room)=1609−41=1568 [W] (Equation 8)

The image reproduced by the thermal camera was actually the projection of a cylindrical object on a two-dimensional plane. Consequently, the lines of sight between the camera and the cylinder radius vary between 0 and 90 degrees. In the latter case, which refers to the lateral parts of the reactor device with respect to camera position, and thereby to the edges of the thermal image, the recorded temperatures may be significantly lower than effective ones. However, the division into rectangles, as adopted in order to calculate the average temperatures, includes these edges, which will therefore appear to be colder than they actually are due to the angle of view of the thermal camera. Once again, the parameters of the experiment took a conservative stance, underestimating temperatures where the effective value was not easily assessable

Regarding calculating power emitted by convection, consider a fluid temperature T_{f} lapping against a surface having area A and temperature T. Heat Q transferred in unit time by convection between the surface and the fluid may be expressed by Newton's relation, in which h is defined as the heat exchange coefficient [W/m² K]:

Q=hA(T−T_{f})=hAΔT [W] (Equation 9)

When the value of h is known, it is possible to evaluate the heat flow; thus, determining h constitutes the fundamental problem of thermal convection. Convection coefficient h is not a thermo-physical property of the fluid, but a parameter, the value of which depends on all the variables that influence heat exchange by convection:

h=f(ρ,Cp,μ,βg,k,T−T_{f},D)
where the meaning of the symbols is as follows:
ρ fluid density [kg/m³]
Cp specific heat capacity at constant pressure [J/kgK]
μ viscosity [kg/ms]
βg product of the coefficient of thermal expansion by gravity acceleration [m/s² K]
k coefficient of thermal conductivity [W/mK]
T−T_{f} (=ΔT) temperature difference between surface and fluid [K]
D linear dimension; in this case, diameter [m].

The value of h may be obtained, for those instances involving the more common geometries and those fluids of greater practical interest, through the use of expressions resulting from experimental tests quoted in mainstream heat engineering literature. In the case of a cylinder with a diameter less than 20 cm immersed in air at a temperature close to 294 degrees Kelvin, the value of h may be had through the following expression:

h=C″(T−T_{f})ⁿD³ⁿ⁻¹ (Equation 10)

where C″ and n are two constants the values of which may be obtained if one knows the interval within which the product between the Grashof number Gᵣ and the Prandtl number Pᵣ falls. These dimensionless numbers are defined as follows:

Gᵣ=βg(T−T_{f})D³ρ²/μ² (Equation 11A)

Pᵣ=Cₚμ/k (Equation 11B)

Gᵣ represents the ratio between the inertia forces of buoyancy and friction forces squared, while Pᵣ represents the ratio between the readiness of the fluid to carry momentum and its readiness to transport heat. For a wide range of temperatures one can say that:

k⁴(βgρ²Cₚ/μk)=36.0 (Equation 12)

For the reactor device average temperature value derived above, the average temperature between the device and the air is equal to:

(T+T_{f})/2=(711.5+289)/2=500.2 [K] (Equation 13)

Once this value is known, one can first of all derive the relevant coefficient of thermal conductivity k. With the aid of Table IV, which holds good for air, the value of k obtained for this temperature is equal to 0.041 [W/mK].

TABLE IV

| k [W/mK] | T [K] |
|---|---|
| 0.0164 | 173 |
| 0.0242 | 273 |
| 0.0317 | 373 |
| 0.0391 | 473 |
| 0.0459 | 573 |

In Table IV, the extreme temperature values given constitute the experimental range. For extrapolation to other temperatures, it is suggested that the data given be plotted as log k vs log T.

From (Equation 12):

(βgρ²Cp)/(μk)=36.0/(0.041)⁴=1.27×10⁷ (Equation 14)

From the definitions of Gᵣ and Pᵣ:

$$\begin{matrix}{G}_{r} {P}_{r} = ( ( β g {ρ}^{2} Cp ) \text{/} ( μ k ) ) ( T - {T}_{f} ) {L}^{3} \\ = ( 1.27 \times {10}^{7} ) ( 711.5 - 289 ) {( 0.1 )}^{3} \\ = 5.36 \times {10}^{6}\end{matrix} \qquad ( Equation 15 )$$

Now consult Table V for the two constants:

TABLE V

| GrPr | n | C″ |
|---|---|---|
| 10⁻⁵-10⁻³ | 0.04 | — |
| 10⁻³-1.0 | 0.10 | — |
| 1.0-10⁴ | 0.20 | — |
| 10⁴-10⁹ | 0.25 | 1.32 |
| >10⁹ | 0.33 | 1.24 |

In Table V, values are related to a horizontal cylinder with a diameter less than 0.2 m.

One may then deduce: C″=1.32, n=0.25. Equation 10 then becomes:

h=(1.32)(711.5−289)^{0.25}(0.1)^{3*0.25-1}=10.64 [W/m² K] (Equation 16)

Substituting Equation 16 into Equation 9, the power emitted by convection is:

Q=(10.64)(1036×10⁻⁴)(711.5−289)=466 [W] (Equation 17)

Regarding the performance for the reactor device 200, a coefficient of performance (COP) value is calculated below. According to the engineering definition, COP is given by the ratio between the output power of a device and the power required by its operation. In order to get the performance (COP) of the reactor device 200, what remains is to add the radiated power to the power dispersed by convection, and to relate the result to the power supplied to the resistor coils. Conservatively, it is associated to these values a percentage error of 10 percent, in order to address various sources of uncertainty: those relevant to the consumption measurements, those inherent in the limited range of frequencies upon which the thermal camera operates, and those linked to the calculation of average temperatures.

From Equations 8 and 17:

1568+466=(2034±203) [W] (Equation 18)

COP=2034/360=5.6±0.8 (Equation 19)

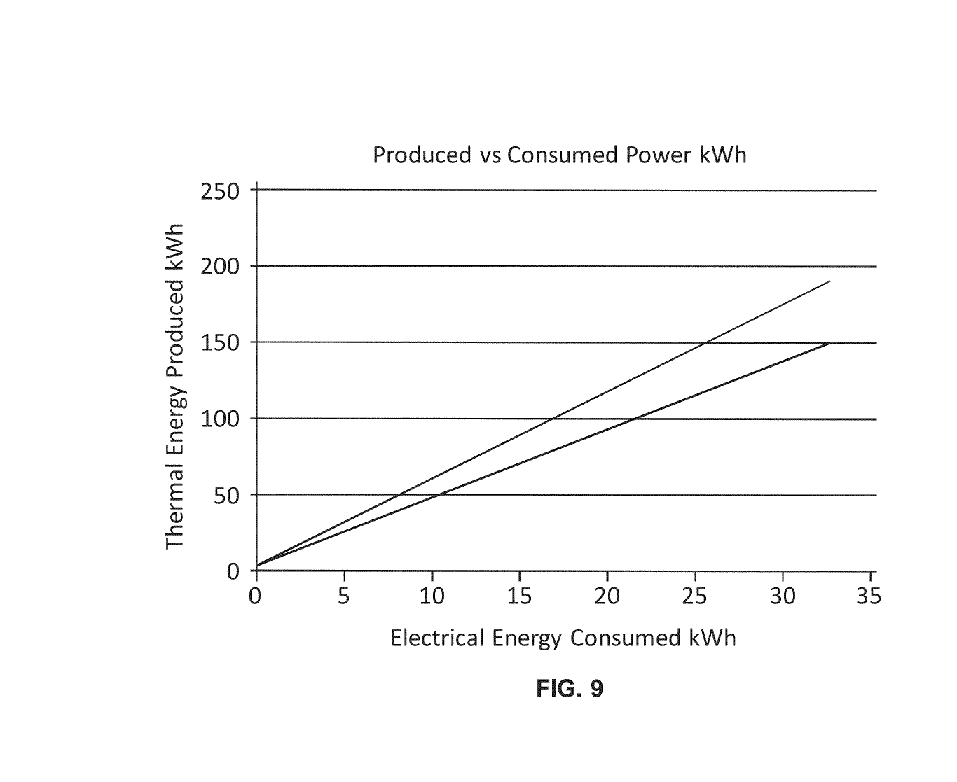

A 10 percent error in power values is assumed in these experiments. FIG. 9 is a plot showing thermal energy produced (kWh) versus electrical energy consumed (kWh). Radiated energy is actually measured energy; total energy also takes into account the evaluation of natural convection. Data are fit with a linear function, and COP is obtained by the slope. In FIG. 9, a slope of 4.4998 and a positive y-intercept of 1.5356 is shown for radiative energy. A slope of 5.7951 and a positive y-intercept of 2.0518 are shown for total energy. The total energy plot lies above the radiated energy plot in FIG. 9

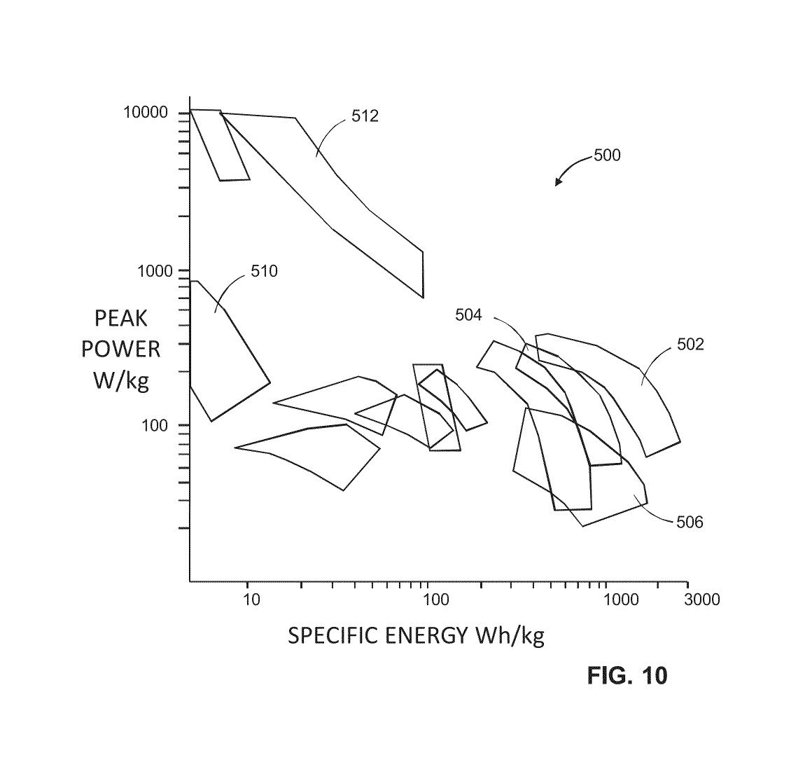

The performance of the reactor device 200, and more specifically its active charge 216 contained therein, can be compared to conventional energy sources by considering the prior-art Ragone chart 500 of FIG. 10. The plot of FIG. 10 shows specific gravimetric power and power densities relevant to various sources on logarithmic scales. For example, gasoline 502, methanol 504, and hydrogen fuel cell 506 zones are shown to reside in higher specific energy areas than conventional flywheel 510 and advanced flywheel 512 zones.

In order to consider the performance of the reactor device 200 in relation to known energy sources and storage technologies, consider that the weight of the active charge of the reactor device 200 plus the weight of the two metal caps sealing the inner cylinder was equal to 0.236 kg. If this is the value assigned to the charge powders, then the weight of the charge will be overestimated; thus, the calculation of the values of power density and the density of thermal energy may be regarded as a lower limit.

Thus, conservatively, for power density:

(2034−360)/0.236=(7093±709) [W/kg] (Equation 20)

Thermal energy density is obtained by multiplying the result of Equation 20 by the number of test hours:

7093×96=680949 [Wh/kg]˜(6.81±0.7)×10⁵ [Wh/kg] (Equation 21)

Power density and thermal energy density found in the second experiment therefore place the reactor device 200 outside of the areas occupied by any known conventional energy source in the Ragone chart. Given the deliberately conservative choices made in performing the measurements, one can reasonably state that the reactor device 200 with its active charge 216 represents a non-conventional source of energy which lies between chemical energy and nuclear energy regimes.

Regarding the second experiment described above, the device 300 subjected to testing was powered by 360 W for a total of 96 hours, and produced in all 2034 W of thermal power. This value was reached by calculating the power transferred by the reactor device 200 to the environment by convection and power irradiated by the device. The resultant values of generated power density (7093 W/kg) and thermal energy density (6.81×10⁵ Wh/kg) allow the reactor device to be placed beyond previously known conventional power sources. The procedures followed in order to obtain these results were extremely conservative, in all phases, beginning from the weight attributed to the powder charge, to which the weight of the two metal caps used to seal the container cylinder was added. The same may be said for the choice of attributing an emissivity of 1 to the device. Other instances of underestimation may be found in the calculation of the radiating area of the device without the two bases, and in the fact that some parts of the radiating surfaces were covered by metal struts. It is therefore reasonable to assume that the thermal power released by the device during the trial was higher than the values given by the above calculations. It should be noted that the device was deliberately shut down after 96 hours of operation. Therefore, from this standpoint as well, the energy obtained is to be considered a lower limit of the total energy which might be obtained over a longer runtime.

### Reactor Device 400 and Third Experimental Results

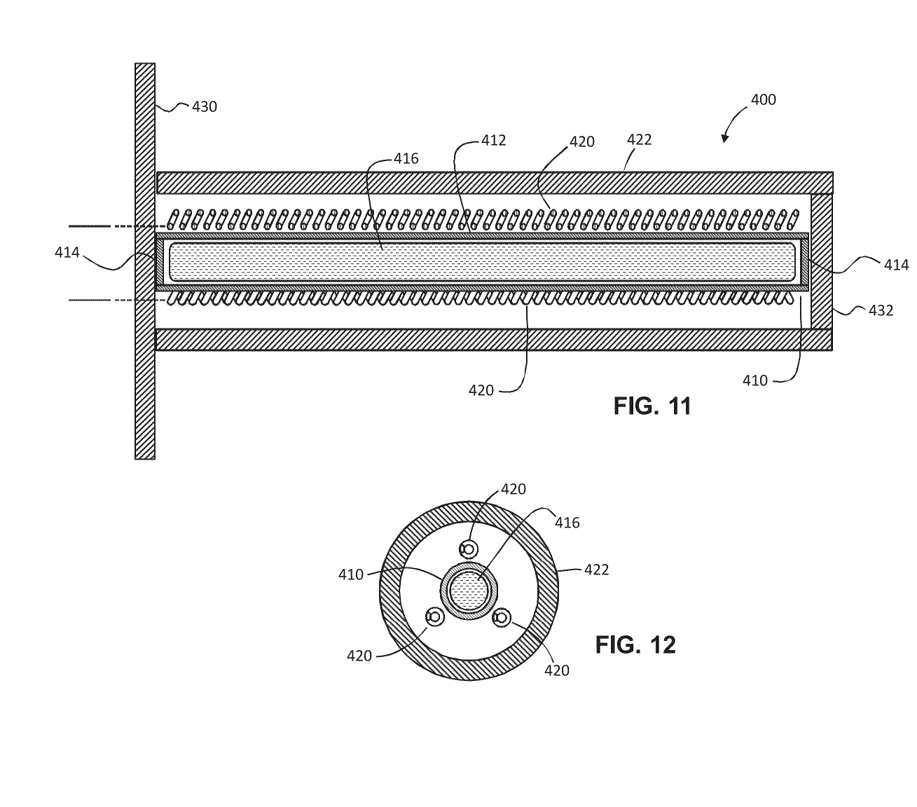

As stated above, three experiments are described herein, of which the first two experiments are described above. The third experiment is described in the following. The third experiment was performed with a reactor device 400 that differed from the earlier described reactor devices 100 and 200 both in structure and control systems. Externally, the reactor device 400 (FIGS. 11-12) had a steel cylindrical outer tube 422, which was 9 centimeters in diameter, and 33 centimeters in length, with a steel circular flange 430 at one end 20 centimeters in diameter and 1 cm thick. A purpose of the flange 430 was to allow the reactor device 400 to be supported while inserted in one of various heat exchangers. As in the other reactor devices 100 and 200, a powder charge 416 was contained within a smaller AISI 310 steel cylindrical inner tube 410. The inner tube had a cylindrical wall 412 that was 3 cm in diameter and 33 cm in length. The inner tube 410 was housed within the outer tube 422, together with the resistor coils 420, and closed at longitudinal ends by two AISI 316 steel caps 414. As such the inner tube 410 constitutes a vessel sealed against ingress or egress of matter, including gaseous hydrogen and other fluids. This represents a distinction of the reactor device 400 over previous reaction vessels that were preloaded with pressured gases such as hydrogen.

Electrical power was fed through the flange 430 to power the resistor coils 420. The third connection was a PT100 sensor 418, used to give a feedback temperature signal to the control box in order to regulate the ON/OFF cycle followed in the third experiment. The power supply used in the third experiment differs from that used in the second experiment. The power supply used in the third experiment was not a three-phase supply, but single-phase supply. That is, the TRIAC power supply used in the second experiment was replaced by a controller circuit having three-phase power input and single-phase output, mounted within a housing.

A significant difference in the reactor device 400 and the earlier described device 200 lies in the control system, which allows the reactor device 400 to work in self-sustaining mode. That is, the reactor device 400 can remain operative and active, while powered off, for much longer periods of time with respect to those during which power is switched on. During the third experiment, after an initial phase lasting about two hours in which power fed to the resistor coils 420 was gradually increased up to operating conditions, an ON/OFF phase was reached. In the ON/OFF phase, power to the resister coils was automatically regulated by the temperature feedback signal from the PT100 sensor.

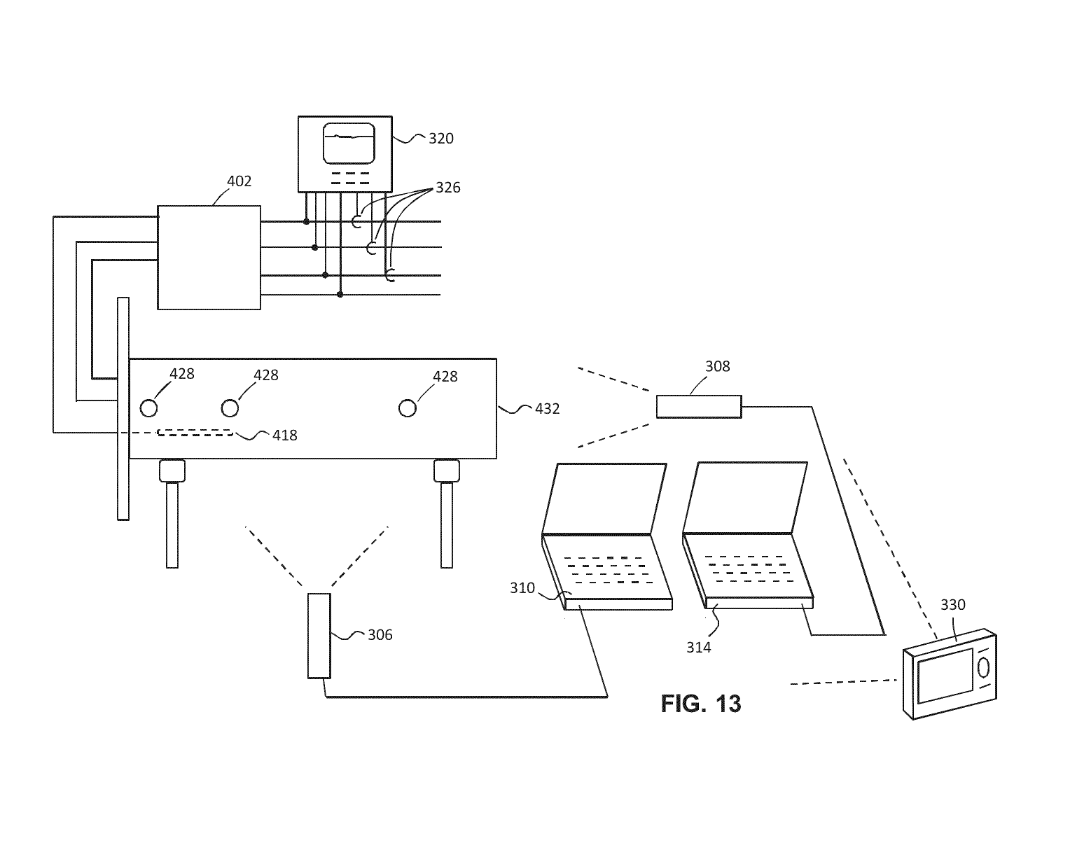

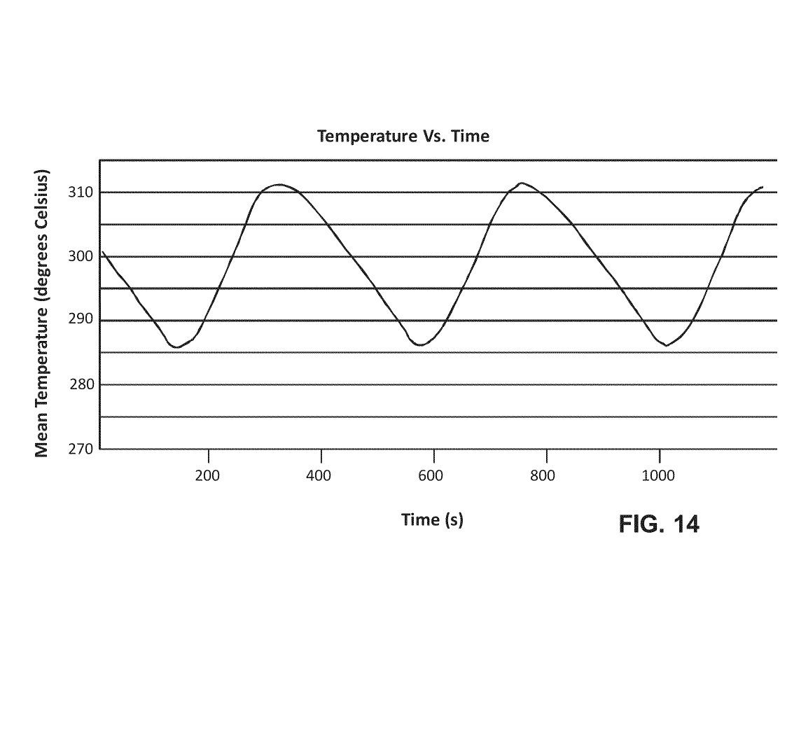

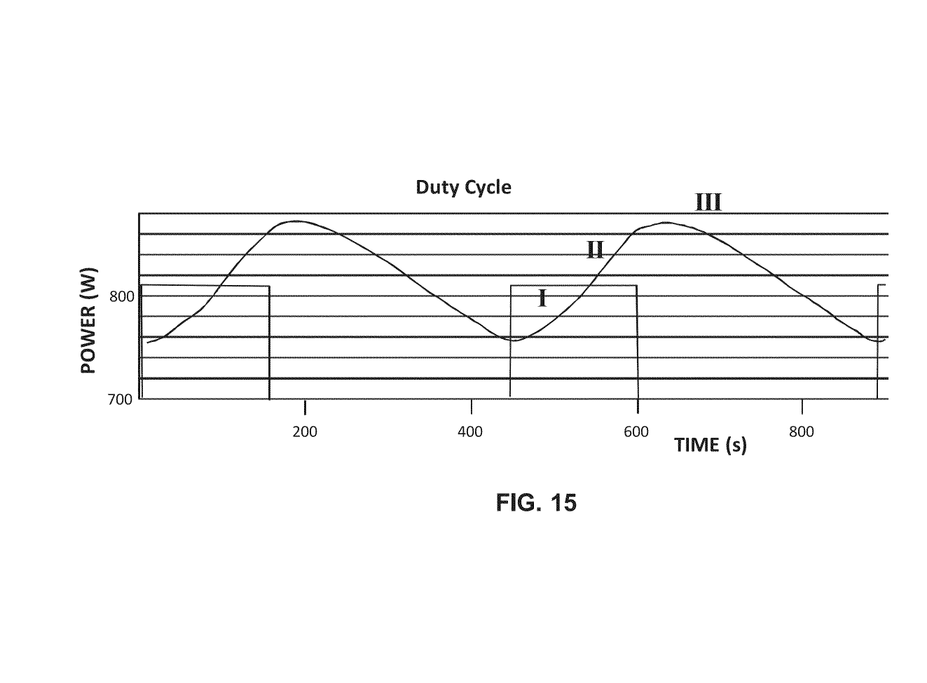

In the ON/OFF phase, the resistor coils 420 were powered up and powered down by the controller circuit 402 (FIG. 13) at observed regular intervals of about two minutes for the ON state and four minutes for the OFF state. This operating mode was kept more or less unchanged for all the remaining hours of the test. During each OFF state, it was possible to observe—by video displays connected to IR cameras (see below)—that the temperature of the device 400 continued to rise for a limited amount of time. The relevant data for this phenomenon are displayed with reference to FIG. 14 and FIG. 15.

The instrumentation of the experimental set-up, as shown in FIG. 13, used for this third experiment was similar to that of the second experiment. However, in addition to the first thermal camera 306, a second thermal camera 308 and computing device 314 were used to measure and visualize the temperature of the base 432 (henceforth: “breech”) of the reactor device 400, and of the flange opposite the base. The second thermal camera 308 was an Optris PI 160 Thermal Imager having a 48 degree by 37 degree lens. Both thermal cameras 306 and 308 were mounted on tripods during data capture, with the reactor device 400 resting on pieces of fiberglass insulation material supported by metal struts. This thermal imaging arrangement made it possible to solve two of the issues experienced during the second experiment, namely the lack of information on the reactor device 200 breech, and the presence of shadows from the struts in the previous IR imagery. The cameras 306 and 308 were placed to view the reactor device 400 along respective horizontal perspectives, with the cameras and reactor device all approximately equidistant from the floor. The LCD display of the power monitor 320 (electrical power meter (PCE-830)), was continually filmed by a video camera 330. Three clamp ammeters 326 (FIG. 13) and three voltage probes 328 of the power monitor 320 were connected upstream from the controller 402 to three power phase inputs. A fourth voltage probe 328 sampled the neutral return input line.

The power monitor 320, in addition to providing voltage and current values for each phase, allows one to check both the waveform and its spectral composition in harmonics of the fundamental frequency (50 Hz). Voltage waveforms were confirmed as sinusoidal and symmetrical, and there were no levels of DC voltage. The instrument's stated measurement error is 2% within the 20th harmonic, and 5% from harmonics 21 to 50. In measurements described herein, a margin of error of 10% was assumed. As far as measurements of current are concerned, it was ascertained that no current was present in the third phase, and that, for the other two phases, the waveform harmonics spectrum, which appeared to be the one normally associated with a TRIAC regulator, was contained within the interval measurable by the instrument.

The issue of emissivity of the reactor device 400 was particularly well addressed in the third experiment. The outer surface of the outer tube 422 and one side of the flange 430 were coated with black paint, different from that used for the second experiment. The black paint used was Macota® enamel paint capable of withstanding temperatures up to 800 degrees Celsius. For this purpose, self-adhesive samples were used. White disks, henceforth “dots,” each approximately 2 centimeters in diameter, were provided by the same firm that manufactures the IR cameras (Optris part: ACLSED). The dots had a known emissivity of 0.95. According to the manufacturer, the maximum temperature tolerated by a dot before it is destroyed is approximately 380° C. In the course of the test, numerous dots 428 were applied along the side and the breech of the reactor device 400. Those dots applied to the more central areas showed a tendency to fall off, and had to be periodically replaced. The distribution of temperatures along the device is non-uniform, and the central part of the cylindrical body is where the temperature reaches values closest to the uppermost working limit for the dots themselves.

The dots allowed a determination of the emissivity of the surface to which they are applied. One compares temperature values recorded on the dots to those of the adjacent areas. This procedure may also be applied during the experiment and/or during post-experiment data analysis directly on a completed thermal imagery video. It is possible to divide the thermal images into separate areas in a manner similar to that used to determine the average temperature of the reactor device 200 in the second experiment described above. A specific emissivity can be assigned to each area. This option proved quite useful when analyzing the imagery captured by the cameras, because it made it possible to correct the values of emissivity (ε) that had been assigned during the initial calibration performed while the test was in progress. The dots in the images helped to determine that different areas of the device had different emissivity because the paint had not been uniformly applied. Furthermore, it was possible to see how emissivity for each area varied in the course of time, probably due to a change in the properties of the paint when subjected to continuous heat. For this reason, when analyzing the data after the third experiment, many time intervals were taken into consideration. The thermal images of the reactor device 400 were then divided into areas, and adjusted to the appropriate values of emissivity relevant to each time interval. In order to calculate emitted energy, the temperature then assigned to each area of the device was determined from an average of the various results that had been obtained.

Another improvement over the second experiment in the third experiment lies in the fact that further measurements (falling outside the 116 hours of the actual experimental period) were performed on the same reactor device 400 used for the test, after removing the inner charge. With this device, termed “dummy,” the effectiveness of the methodology used to evaluate the active device was verified, and the energy emissions of the flange were estimated, which would have been difficult to evaluate otherwise. Furthermore, as in the second experiment, the reactor device 400 was assessed all throughout the third experiment for potential radioactive emissions. The measurements and their analysis were performed once again by a qualified person, whose conclusions are summarily quoted as “The measurements performed did not detect any significant differences in exposure and CPM (Counts per Minute), with respect to instrument and ambient background, which may be imputed to the operation of the [prototypes.]”

By “dummy” is meant here the same reactor device 400, but provided with an inner cylinder 410 lacking both the steel caps and the powder charge. This “unloaded” device was subject to measurements performed after the 116-hour third experiment, and was kept running for about six hours. Instrumentation and data analysis were the same as those used for the test of the active reactor device 400 with the charge 416. The data relevant to the dummy made it possible to perform a calibration of the reactor device 40.

The electrical power to the dummy was handled by the same controller 402 (FIG. 13), but with electrical power applied continuously as opposed to ON/OFF cycling. Power to the dummy resistor coils was stepped up gradually, waiting for the device to reach thermal equilibrium at each step. In the final part of the test, the combined power to the dummy and control box was around 910-920 W. Resistor coil power consumption was measured by placing the instrument in single-phase directly on the coil input cables, and was found to be, on average, about 810 Watts. From this one derives that the power consumption of the control box was approximately 110-120 Watts. At this power, the heat produced from the resistor coils alone determined an average surface temperature (flange and breech excluded) of almost 300° C., which is very close to the average one found in the same areas of the reactor device 400 during the live test.

Various dots were applied to the dummy as well for emissivity determination. A K-type thermocouple heat probe was placed under one of the dots to monitor temperature trends in a fixed point. The same probe had also been used with the active reactor device 400 to double check the thermal camera readings during the cooling phase. The values measured by the heat probe were always higher than those indicated by the thermal camera. The difference in temperature, which was minimal in the case of the active reactor device, was more noticeable in the dummy, where temperature readings proved to be always higher by about 2 degrees Celsius. The most likely reason for the difference is to be sought in the fact that the probe, when covered with the dot securing it the surface, could not dissipate any heat by convection, unlike the areas adjacent to it.

In order to evaluate the power emitted by the dummy by radiation and convection, the image of the cylindrical body was divided into 5 areas, to each of which was assigned, by the dots, an average emissivity of 0.80. Lastly, the analysis of images relevant to the breech determined for this area another value for emissivity (ε): 0.88.

For each of the five areas, energy emitted by radiation was calculated. Once again, Stefan-Boltzmann's formula multiplied by the area taken into consideration was used, as in Experiment 2 (Equation 5). Power emitted by convection was calculated by Equations 9 and 10. The equations are repeated below for clarity's sake, followed by a table summarizing the results.

E=εσΔT⁴ [W] (Equation 5)

Q=hA(T−T_{f})=hAΔT [W] (Equation 9)

h=C″(T−T_{f})ⁿD³ⁿ⁻¹ (Equation 10)

Area_{Dummy}=2πRL=989.6×10⁻⁴ [m²]

Area_{Top}=πR²=63.61×10−4 [m²]

Note that coefficients C″ and n in Equation 10 have the same value calculated for the above-described Experiment 2, namely C″=1.32, and n=0.25, whereas the diameter D is now=9 cm. Moreover, Area_{Dummy} refers to the cylindrical body of the device without flange or breech. Lastly, the contributing factor due to ambient temperature, termed “E(room)” in (7) above, has already been subtracted from the power values associated with each area. This was calculated assuming an ambient temperature value of 14.8 degrees Celsius.

E(room)=(5.67×10⁻⁸)(288)⁴(0.80)(198×10⁻⁴)=6.18 [W]

TABLE VI

| | Area 1 | Area 2 | Area 3 | Area 4 | Area 5 | Sum |
|---|---|---|---|---|---|---|
| E (W) | 84.9 | 112 | 109 | 102 | 49.3 | 457.2 |
| Q (W) | 53.7 | 63 | 62.6 | 59.9 | 38.3 | 277.5 |
| W Total | 138.6 | 175 | 171.6 | 161.9 | 87.6 | 734.7 |

Table VI shows the power emitted by radiation (E) and convection (Q) for each of the five areas. The value of E(room), about 6.18 W, has already been subtracted from power E in the relevant area.

Using the second thermal imagery camera, it was possible to monitor the temperature of the breech, which was almost stable at 225 degrees Celsius. One may compute the contributing factor to the total radiating energy associated with this part of the dummy: a value of E-E(room)=17 W. As for the flange, it was not possible to evaluate its temperature with sufficient reliability, despite the fact that it was partially framed by both IR cameras. A careful analysis of the relevant thermal imagery revealed how part of the heat emitted from the flange was actually reflected heat coming from the body of the dummy. In fact, the position of the flange is such that one of its sides constantly receives radiative heat emitted by the body of the cylinder: if one were to attribute the recorded temperature to the flange, overestimating the total radiative power would be risked. Conservation of energy was used to evaluate the contributing factor of the flange, and of all other not previously accounted factors, to the total energy of the dummy. Thus, one arrives at:

810 [W]−(735+17) [W]=58 [W] (Equation 22)

This last value is the sum of the contributive factors relevant to all unknown values, namely: flange convection and radiation, breech convection (NB convection only), losses through conduction, and the margin of error associated with the evaluation.

Since the temperatures reached by the dummy and by the reactor device 400 during their operation were seen to be quite similar, this value will also be used to calculate the power relevant to the reactor device 400, where it will be attributed the same meaning.

Regarding the analysis of data obtained with the reactor device 400 of the third experiment, upon initiation, the initial power input was about 120 W, gradually stepping up during the following two hours, until a value suitable for triggering the self-sustaining mode was reached. From then onwards, and for the following 114 hours, input power was no longer manually adjusted, and the ON/OFF cycles of the resistor coils followed one another at almost constant time intervals. During the coil ON states, the instantaneous power absorbed by the reactor device 400 and the controller circuit 402 together was visible on the display of the power monitor 320. This value, with some fluctuations in time, remained in any case within a range of 910-930 W. The power monitor display showed the length of the ON/OFF intervals: with reference to the entire duration of the test, the resistor coils were on for about 35% of the time, and off for the remaining 65%.

As in the case of the dummy, in order to determine the average temperatures for the reactor device 400, it was opted to divide its thermal images into five areas, plus another one for the breech. An analysis of various time segments (about five hours each), taken in the course of each day of the test, revealed that the behavior of the device remained more or less constant, and became quite stable especially from the third day onwards. Using the same procedure as before, an average temperature for each of the five areas was obtained, thereafter employing equations (5), (9), and (10) in order to calculate power emitted by radiation and convection, respectively.

In a typical thermal image taken of the reactor device 400, the flange did not appear in the image because the display range chosen for the thermal camera does not detect objects colder than 150 degrees Celsius.

Emissivity values for each area were adjusted in each thermal camera video sample thanks to the continuing presence of the dots: according to position and time, the found values for emissivity (ε) fluctuated between a low of 0.76 and a high of 0.80. Areas subject to the most intense heat were seen to have slightly higher emissivity compared to peripheral ones, and all showed a slight upward trend as the test progressed, probably because of a change in the properties of the paint.

In order to account for a certain degree of arbitrariness inherent in this method of evaluation, it was decided to assign a reference temperature to the various areas of the device. This was obtained by assigning to all areas the most frequently found value for emissivity (ε) and associating a percentage error to it. This error is the result of the difference between two extreme values, namely the temperature obtained by assigning to all areas the lowest level of emissivity ever found in any one of them (=0.76), and the temperature obtained assigning to all areas the highest value for emissivity ever found (=0.80). Tables VII and VIII summarize the results: the first refers to the average of temperatures in each of the five areas for different values of emissivity, whereas the second gives the average values of power emitted by radiation (E) and convection (Q) for different values of emissivity (ε), while taking into account the sum performed on the five areas.

TABLE VII

| | | | T 3 | | T 5 | |
|---|---|---|---|---|---|---|
| ε | T 1 (° C.) | T 2 (° C.) | (° C.) | T 4 (° C.) | (° C.) | Average |
| Average ε | 261.0 | 319.4 | 326.0 | 318.3 | 286.9 | 302.3 |
| 0.76 | 261.0 | 328.4 | 335.2 | 327.3 | 286.9 | 307.7 |
| 0.80 | 254.0 | 319.4 | 326.0 | 318.4 | 279.2 | 299.4 |

Table VII provides average temperatures relevant to the divisions into five areas of the reactor device 400 cylindrical body, calculated according to average values of emissivity (first row), absolute minimal values (second row), and absolute maximum values (third row), collated by taking into consideration all the areas and all the analyzed time intervals. The last column gives the averages of the previous values for each of the five areas.

TABLE VIII

| E | E (W) | Q(W) | E(W) + Q(W) |
|---|---|---|---|
| Average ε | 459.8 | 281.5 | 741.3 |
| 0.76 | 463.8 | 288.2 | 752.0 |
| 0.80 | 458.6 | 277.9 | 736.6 |

Table VII provides emitted power values by radiation (E) and by convection (Q) for different values of emissivity (ε). The values are computed from the power average of all five areas, minus the E(room) component arising from the contributing factor of ambient temperature.

The error associable to the average value of emitted power may be got by taking into account the difference between what is obtained by attributing to each area the highest possible and the lowest possible value for ε. Thus:

(752.0−736.6)/741.3=2 percent (Equation 23)

As may be inferred from the last value above, the uncertainty regarding emissivity does not affect the results much, and should therefore be considered a parameter of lesser critical import than what was originally estimated.

The average temperature relevant to the breech, as well as its average emissivity, turned out to be extremely constant over time, with values of 224.8 degrees Celsius and 0.88, respectively. One can therefore associate them with a value of irradiated power E-E(room)=17 [W].

At this point, all the contributing factors relevant to the thermal power of the reactor device 400 of the third experiment are available: the power emitted by the cylindrical body through radiation and convection; the power emitted by radiation by the breech; and the set of missing factors (conduction, breech convection, flange radiation and convection). It is now possible to obtain a complete estimate:

Emitted Power=(741.3+17+58) [W]=(816.3±2%) [W]=(816±16) [W] (Equation 24)

Upon completion of the test, the reactor device 400 of the third experiment was opened, and the innermost cylinder, sealed by caps and containing the powder charges, was extracted. It was then weighed (1537.6 g) and subsequently cut open in the middle on a lathe. Before removal of the powder charges, the cylinder was weighed once again (1522.9 g), to compensate for the steel machine shavings lost. Lastly, the inner powders were extracted, and the empty cylinder was weighed once again (1522.6 g). The weight that may be assigned to the powder charges is therefore on the order of 0.3 grams. Here it shall be conservatively assumed to have a value of 1 gram, in order to take into account any possible source of error linked to the measurement.

According to the data available from the PCE-830 analyzer power monitor, the overall power consumption of the reactor device 400 and the control box 402 combined was 37.58 kWh. The associated instantaneous power varied between 910 and 930 W during the third experiment, so it may be averaged at 920±10 W. In order to determine the power consumption of the reactor device alone, one must subtract from this value the contributive factor of the control box power consumption. As it was not possible to measure the latter while the test on the reactor device was in progress, one may refer to the power consumption of the box measured during the dummy test. This value would in all likelihood be higher in the case of the operative reactor device, due to the electronic circuits controlling the self-sustaining mode. The more conservative parameter was adopted.

If one assumes that the control box 402 absorbed about 110 W, the reactor device 400 has a consumption of:

Instant Power Consumption=(920−110) [W]=810 [W] (Equation 25)

Keeping in mind the fact that this consumption was not constant over time, but may be referred just to 35% of the total test hours, one may calculate the effective power consumption of the device as:

Effective Power Consumption=(810/100)×35=283.5 [W] (Equation 26)

Further assume an error of 10%, in order to include any possible unknown source. Errors of this extent are commonly accepted in calorimetric measurements, and in this case they would comprise various sources of uncertainty: those relevant to the consumption measurements of the reactor device 400 and the control box 402, those inherent in the limited range of frequencies upon which the thermal cameras operate, and those linked to the calculation of average temperatures. The energy produced by the reactor device during the 116 hours of the test is then:

Produced Energy=(816−283.5) 116=(6.2±0.6)×10⁴ [Wh] (Equation 27)

From Equation 27, the parameters necessary to evaluate the position held by the reactor device 400 with respect to a Ragone Plot may be determined, where specific energy is represented as a function on a logarithmic scale of the specific power of the various energy storage technologies.

For power density:

(816−283.5)/0.001=532500 [W/kg]−5×10⁵ [W/kg] (Equation 28)

Thermal energy density is obtained by multiplying the value found in Equation 28 by the number of test hours:

532500×116=(6.2±0.6)×10⁷ [Wh/kg]−6×10⁷ [Wh/kg] (Equation 29)

It is easy to infer from the Ragone chart (FIG. 10), that these values place the active charge 416 of the reactor device 400 at about three orders of magnitude beyond any other conventional chemical energy source.

Now repeat the last calculation supposing, as a precautionary measure, that all power consumption is assigned to the reactor device 400, without consideration toward power consumed by the controller box 402 (FIG. 13). According to this logic, and assigning to the reactor device 400 the maximum value of error given by Equation 24, namely (816−16) W=800 W, one gets:

Conservative Consumption=(920/100)×35=(322±32) [W] (Equation 30)

Equations 28 and Equation 29 become:

(800−322)/0.001=(4.7±0.5)×10⁵ [W/kg] (Equation 31)

478000×116=(5.5±0.6)×10⁷ [Wh/kg] (Equation 32)

The results thus obtained are still amply sufficient to rule out the possibility that the reactor device 400 draws upon a conventional source of energy. Let us associate to this last value of conservative power consumption the worst-case scenario:

(322+32) [W]=354 [W] (Equation 33)

Then the values of power density and energy density would be:

(800−354)/0.001=(4.4±0.4)×10⁵ [W/kg] (Equation 34)

446000×116=(5.1±0.5)×10⁷ [Wh/kg] (Equation 35)

Obviously, not even in this case is there any substantial change regarding whether the energy source under consideration falls among previously known chemical energy sources in the Ragone plot.

For a further confirmation of the fact that the performance lies outside the known region of chemical energy densities, one can also calculate the volumetric energy density of the reactor device 400, by referring to the whole volume occupied by the internal cylinder, namely 1.5²π33=233 cm³=0.233 liter. This is the most conservative and “blind” approach possible.

Taking the values from the worst case, one gets a net power of 800−354=446 W; by multiplying this by (3600×116), one finds that 185 MJ were produced. This corresponds to a volumetric energy density of 185/0.233=(7.93±0.8)102 MJ/liter, meaning that even by resorting to the most conservative and “worst case scenarios,” where the total volume of the reactor is comprehensive of the 5-mm thick steel cylinder, the values are at least one order of magnitude above the volumetric energy density of any known chemical source.

For further performance considerations, one can consider a COP calculation. According to the engineering definition, COP is given by the ratio between the output power of a device and the power required by its operation, thereby including, in this case, the power consumed by the control electronics. For the reactor device 400, one would therefore have (assuming a 10% uncertainty in the powers):

COP=816/322=2.6±0.5 (Equation 36)

In order to compare this figure with the COP value obtained in the second experiment (5.6; see Equation 19), one must first of all consider that the two values were obtained in different experimental contexts: Equation 19 gives the ratio between power emitted and power consumed by the reactor device 200 only, without the TRIAC power supply, whereas Equation 36 includes power consumption by the control device instrumentation of the reactor device 400. The expression useful for such a comparison is therefore the following:

COP=816/283=2.9±0.3 (Equation 37)

Thus, Equation 19 and Equation 37 give the performances specific to reactor device 200 (the second experiment) and reactor device 400 (the third experiment), respectively, regardless of the electronic circuits used to control them.

The reasons for the appreciable difference between the values obtained in the second and third experiments are probably to be sought in the tendency of the COP to increase with temperature, a fact which was noticed even in the first experiment. In that occasion, reaching a certain critical temperature threshold was enough to cause the reaction to diverge uncontrollably and destroy the device. Considering that, in the second experiment, the average temperature of the reactor device 200 was 438 degrees Celsius, versus an average of 302 degrees Celsius for the reactor device 400 in the third experiment, a higher COP for the former device with respect to that found in the latter was by no means unexpected. It is possible that the two coefficients of performance (COP) differ only because the quantities of powder used in the two experiments were different.

An interesting aspect of the reactor device 400 of the third experiment is certainly its capacity to operate in self-sustaining mode. The values of temperature and production of energy which were obtained are the result of averages not merely gained through data capture performed at different times, they are also relevant to the resistor coils' ON/OFF cycle itself. By plotting the average temperature versus time for a few minutes as shown in FIG. 14, one can clearly see how it varies between a maximum and a minimum value with a fixed periodicity. In FIG. 14, the average surface temperature trend of the reactor device 400 over several minutes of operation is plotted. Note the heating and cooling trends of the device, which appear to be different from the exponential characteristics of a generic resistor. What appears indicated here is that the priming mechanism pertaining to the reaction inside the device speeds up the rise in temperature, and keeps the temperatures higher during the cooling phase.

Another very interesting behavior is brought out by synchronically comparing another set of curves: power produced over time by the reactor device, and power consumed during the same time. An example of this may be seen in FIG. 15, which refers to three intervals (I, II, III). The resistor coils ON/OFF cycle is plotted as a step function, while the power-emission trend of the device appears as a smoothly varying curve. Starting from any lowest point of the step function, one can distinguish three distinctive time intervals in the power-emission curve. In the first (interval I), emitted power rises, while remaining below the input power of the step function, representing consumed power. In the second (interval II), emitted power rises above consumed power, and approaches its peak while the resistors are still on. In the third (interval III), after the resistors have been turned off, emitted power reaches its peak and then begins to fall to a new minimum value, whereupon the resistors turn on again. In the first time interval, emitted power is less than consumed power; but already in the second the trend reverses, and continues as such into the beginning of the third interval.

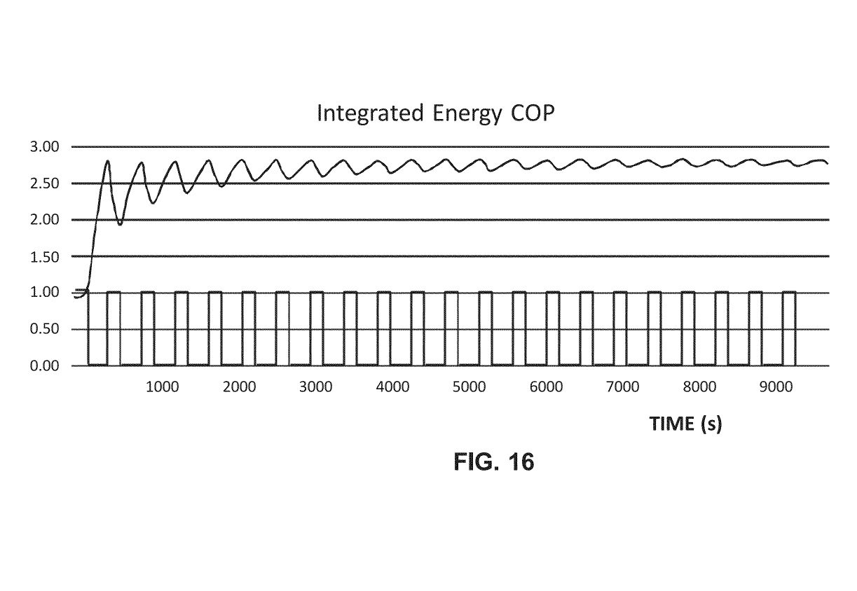

One may further analyze the trend of the ratio between energy produced and energy consumed by the reactor device 400 of the third experiment. In FIG. 16, the upper saw-tooth plot is the result of the analysis, and is reproduced here together with the step-function plot of power consumption normalized to 1. Basically, for every second taken into account, the corresponding value of the upper curve is calculated as the ratio between the sum of the power per second emitted in all the previous seconds, and the sum of the power per second consumed in all the previous seconds.

The two test measurements described above for the second and third experiments were conducted with similar methodologies on two different devices. Both gave indication of heat production from an internal reaction primed by heat from resistor coils. The results obtained indicate that energy was produced in decidedly higher quantities than what may be gained from any previous chemical source. In the third experiment, approximately 62 net kWh were produced, with a consumption of about 33 kWh, a power density of about 5.3×10⁵, and a density of thermal energy of about 6.1×10⁷ Wh/kg. In the second experiment, about 160 net kWh were produced, with a consumption of 35 kWh, a power density of about 7×10³ W/kg and a thermal energy density of about 6.8×10⁵ Wh/kg. The difference between the two results may be seen in the overestimation of the weight of the charge in the second experiment, which included the weight of the two metal caps sealing the cylinder, and in the choice of keeping temperatures under control in the third experiment to enhance the stability of the operating cycle. In any event, the results obtained place both devices several orders of magnitude outside the bounds of the Ragone plot region for chemical sources.

Even from the standpoint of a “blind” evaluation of volumetric energy density, if one considers the whole volume of the reactor core and the most conservative figures on energy production, one will still get a value of (7.93±0.8)×10² MJ/liter that is an order of magnitude higher than any conventional chemical source. Both tests were terminated by a deliberate shutdown of the reactor, not by fuel exhaustion; thus, the energy densities that were measured should be considered as lower limits of real values.

### System 600 and Experimental Results

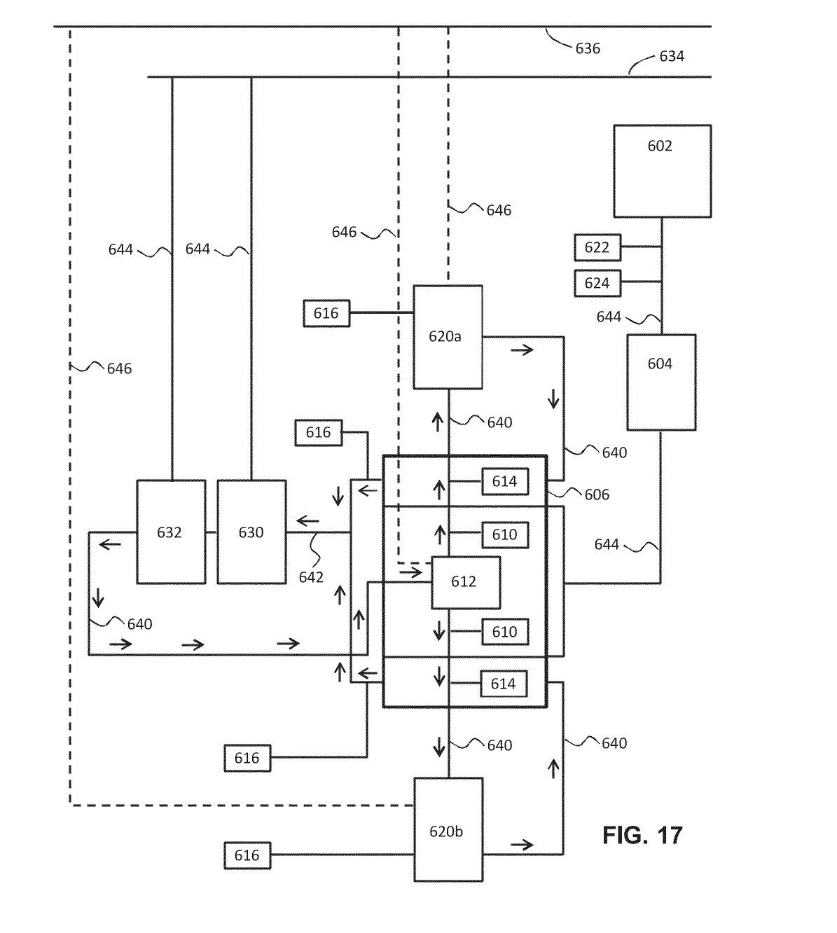

A system 600 for producing heat, according to at least one embodiment, is illustrated in FIG. 17. According to at least one embodiment, the system includes a high number of individual reactor devices. The reactor device 400 described above represents an exemplary choice for use in the system 600, although other reactor devices including reactor device 200 and others are within the scope of these description of the system 600. In a particular example of the system 600, a total number of 18 reactor devices are used. Each of the reactors may absorb a power of about 1.1 kW.

Each reactor device, according to these descriptions, includes a reaction chamber in which nickel powder and hydrogen react in the presence of a catalyst. Electrical resistance heaters may be used to trigger the reactions in the reactor devices, for example as according to the descriptions above with regard to Experiments 1, 2 and 3 (FIGS. 1-16). The power generator 602 provides the input electrical energy to trigger reaction initiation.

A power panel 604 downstream of the power generator 602 regulates the electrical current input to the reactor devices. The power panel 604 may operate according to computer control codes in which an automated process of monitoring is carried out by the power panel 604. Alternatively, the power panel 604 may include operator responsive buttons such that a human operator can monitor the heat generation process and control an output thereof.

The electric heaters are positioned within a reactor shelter 606, which represents a collective thermal housing of the multiple reactor devices and/or represents individual reactor shelters in one-to-correspondence with multiple reactor devices, according to the variation of the system 600 within the scope of these descriptions. According to such variations, powering the electric heater triggers exothermic reactions in the reactor devices.

The energy and/or heat produced by the exothermic reactions is controlled and collected by heat transfer, for example using a fluid in a heat exchange arrangement. For example, a heat exchange fluid, such as water, may be arranged in thermal contact with the reactor devices or reactor shelter 606 using pumps 610 and a reservoir 612 within the reactor shelter 606. Flow meters 614 generate data signals for analysis in regulating flow. Although water is particularly described here as an example of a heat exchange fluid, other fluids capable of supporting heat transfer may be employed.

The control of the heat generation by exothermic reactions may be performed by a computing device that measures one or more factors such as, for example, temperature measured by temperature probes 616. The temperature probes may detect the temperature of water and/or steam, and other temperature conditions, in any portion of the system 600, including entry into the reactor shelter 606. The flow rates of cooling fluids may be manually set to or varied to regulate operations. For example, flow rates may be varied according to operator controls or according to one or more computing systems.

In a particular embodiment of the system 600, which was evaluated according to an experiment described herein as the fourth experiment, the system 600 included the elements detailed in TABLE IX:

TABLE IX

| Quantity | Item |
|---|---|
| 1 | 300 kW power generator (602, FIG. 17) |
| 2 | water pump: model EEM, Tellarini pompe, 0.37 kW (610, |
| | FIG. 17) |
| 18 | reactor devices within reactor shelter (606, FIG. 17) |
| 24 | water pump: model Prominent Gamma, 23 w |
| 56 | water pump: Prominent Concept plus, 15 w |
| 2 | heat sinks |
| 2 | water tank: 1 cubic meter capacity each (620, FIG. 17) |
| 2 | flow meters (614, FIG. 17) |
| 1 | manometer |
| 4 | instruments with a probe and/or sensor for temperature |
| | measurement by immersion |
| 1 | multifunction calibrator (622, FIG. 17) |
| 1 | power analyzer (624, FIG. 17) |

The water contained in the two tanks 620, placed at the sides of the reactor shelter 606, is conveyed by pumps 610 into the reactor shelter. The water is then heated by the reactor devices to vaporize into steam. The steam is collected in the two tubes of the steam line. The steam is then conveyed to the outside of the reactor shelter housing the water pumps and flow meters. The two tubes are then combined into a single tube.

The vapor is then passed through successive air exchangers 630 and 632 as the steam condenses. The condensed water is then conveyed into the water reservoir 612 which is placed inside of the reactor shelter 606. The water is then conveyed to water tank 1 (620a) and water tank 2 (620b), where the temperature of the water is measured.

The generator 602 powers the reaction triggering heating elements of the reactor devices, the pumps for the water, and the internal services to the reactor shelter and the control panel. The heat sinks 630 and 632, which were fans (air exchangers) in this experiment, were connected to the public electric grid via outside power line 634. Line 636 represents an outside hydraulic line. Furthermore in FIG. 6: lines 640 represent water lines; lines 642 represent steam lines; lines 644 represent power lines; and lines 646 represent emergency hydraulic lines.

In the experiment, the generator was activated. Exit temperatures of steam and water tank 620a were measured. Exit temperatures of steam were automatically recorded, as well as temperature in tank 620a. The process was then shut down and temperature recording was ceased. The coefficient of performance (COP) can be considered in the experiment as:

COP=Energy Produced (Ep)/Energy Absorbed (Ea)

The energy produced by 18 reactors is given by the sum of the heat of heating of water, heat of vaporization of water and heat of superheating the steam.

Ep=ER+EV+ES (Equation 38)

ER is the energy of heating of water up to 100° C., calculated as:

ER=MW1×Csw×(Tev−Tiw1)+MW2×Csw×(Tev−Tiw2) (Equation 39)
where:
MW1=mass of water vaporized during the whole test, coming from tank 1
TiW1=inlet temperature of the water, coming from tank 2
MW2=mass of water vaporized during the whole test, coming from tank 2
TW2=inlet temperature of the water, coming from tank 2
Csw=specific heat of water=1.14 Wh/(kg degrees Kelvin)
Tvw=vaporization temperature of the water=100 degrees Celsius
EV=(energy of vaporization of water)=λ×(MW1+MW2)
λ=(latent energy of vaporization)=627.5 Wh/kg
ES=Ms×Cps×(Tos−Tvw) Ms=mass of steam produced during the whole test
ES is the heating energy of steam.
Cps is the specific heat of steam at constant pressure, having a value here of 0.542 Wh/kg.
Tos=outlet temperature of the steam.
Tvw=vaporization temperature of the water

Throughout the test, the temperatures of steam measured by the two probes have always been the same or very similar to each other. Throughout the test, the pressure of the steam was always equal to atmospheric pressure

In order to be conservative, it has not been taken into account the heating energy of steam. The temperature of the inlet water has always been considered equal to the maximum value of the same measured during the whole test. The uncertainty of measurement of the mass of water heated all were considered. Consequently, the total mass of water transited during the trial period has been reduced by 10%.

Regarding calculation of the energy absorbed (Ea), the absorbed energy was generated by the generator 602. In order to be conservative, all the energy produced by the generator is assumed to be absorbed by the 18 reactors. In reality, a part of this energy feeds the pumps, which convey the water from the internal reservoir to the two external tanks and pumps, which convey the water from the tanks external to the reactors. This energy then would not have gone to feed the reactors. All the energy produced by the generator since its activation has been taken into account in the context of the test.

The COP has been considered only during the period, in which the reactor devices were operating, namely when the temperature of the steam at ambient pressure was higher than 101 degrees Celsius. The COP has not been considered during the phases of activation and de-activation.

At the beginning of the test, the following values were measured:
MW1b=1050 kg
MW2b=2100 kg
TiW1=21.6 degrees Celsius
TiW2=22.4 degrees Celsius
Tos=121.3 degrees Celsius
Energy produced by generator set=8.98 KWh

At the end of the operational period, the following values were measured:
MW1e=1750 kg
MW2e=3900 kg
TiW1=54.4 degrees Celsius
TiW2=46.8 degrees Celsius
Tos=139.7 degrees Celsius
Energy produced by generator set=140.7 KWh
ER=MW1×Csw×(Tev−Tiw1)+MW2×Csw×(Tev−Tiw2)
MW1=(MW1e−MW1b)=1750−1050=700 kg
MW2=(MW2e−MW2b)=3900−2050=1850 kg
and reducing by 10%
MW1=630 kg
MW2=1665 kg

During the test the highest value of TiW1 is equal to 54.9 degrees Celsius. The highest value of TiW2 is equal to 55.2 degrees Celsius. Substituting the values results in:

$$\begin{matrix}ER = 630 \times 1.14 \times ( 100 - 54.9 ) + 1665 \times 1.14 \times ( 100 - 55.2 ) \\ = 32391 + 85035 \\ = 117426 Wh\end{matrix}$$

$$\begin{matrix}EV = λ \times ( MW 1 + MW 2 ) \\ = 627.5 \times ( 630 + 1665 ) \\ = 627.5 \times 2295 \\ = 1440113 Wh\end{matrix}$$

$$ES = Ms \times Cps \times ( Tos - Tvw ) [ was not taken into account ]$$

$$\begin{matrix}Ea = 140.70 - 8.98 \\ = 131.72 Kwh\end{matrix}$$

The following was taken into account:

Ea=140.70 kWh=140700 Wh

COP=(117426+1440113)/140700=1557539=11.07

Throughout the test, the temperature of the outlet steam was always significantly higher than 100 degree Celsius.

Thus, a system for capturing generated heat is provided. The system includes a heat generator according to the one or more devices disclosed herein and a liquid exchanger configured for passing fluid into heat transfer arrangement with the heat generator and configured for condensing heated liquid. A method for generating energy is also provided. The method includes generating heat with a heat generator according to the one or more devices disclosed herein and passing cooling fluids into heat transfer arrangement with the heat generator and condensing the heated fluids.

There are multiple applications of the one or more devices disclosed herein. In combination of the electrical heat source and fuel, usable heat is generated. This usable heat may be employed with the exchangers disclosed herein. Additionally, the heat generated by the device has its own thermal pattern that may be usable. For example, where the temperature of the device exceeds the temperature of the heating source being employed, selective application of heat in a high temperature zone may be advantageous. In this regard, the coefficient of performance may vary significantly while still providing advantageous heat generation.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A reactor device comprising:
a sealed vessel defining an interior;
a fuel material within the interior of the vessel; and
a heating element proximal the vessel,
wherein the fuel material comprises a solid including nickel and hydrogen, and
further wherein the interior of the sealed vessel is not preloaded with a pressurized gas when in an initial state before activation of the heating element.

2. The reactor device of claim 1, wherein the sealed vessel contains no more than a trace amount of gaseous hydrogen.

3. The reactor device of claim 1, wherein the sealed vessel is sealed against gas ingress or egress.

4. The reactor device of claim 1, further comprising a first ceramic shell between the sealed vessel and the heating element.

5. The reactor device of claim 4, further comprising a second ceramic shell surrounding the first ceramic shell and the heating element.

6. The reactor device of claim 1, wherein the sealed vessel consists of steel.

7. The reactor device of claim 1, wherein the sealed vessel comprises a steel tube having two ends sealed by steel caps.

8. The reactor device of claim 1, wherein the interior of the sealed vessel is cylindrical, and wherein the fuel material is uniformly distributed within the interior of the sealed vessel.

8. The reactor device of claim 1, wherein the heating element surrounds the sealed vessel.

9. The reactor device of claim 1, further comprising a first ceramic shell surrounding the sealed vessel and surrounded by the heating element.

10. The reactor device of claim 9, further comprising a second ceramic shell surrounding the heating element.

11. The reactor device of claim 1, wherein the heating element comprises a resistor coil assembly.

12. The reactor device of claim 12, wherein the heating element comprises at least three resistor coils that are disposed of parallel to and equidistant from a center axis of the device.

13. A method comprising:
providing a sealed vessel with a fuel material therein, wherein the interior of the sealed vessel is not preloaded with a pressurized gas when in an initial state;
heating the sealed vessel with an input amount of energy without ingress or egress of material into or out of the sealed vessel during heating; and
receiving from the sealed vessel an output amount of thermal energy.

14. The method of claim 13, wherein heating the sealed vessel comprises heating the sealed vessel from outside the sealed vessel.

15. The method of claim 13, wherein heating the sealed vessel comprises initiating a reaction within the vessel of a fuel material having a specific energy greater than 1×10⁵ watt×hour/kg.

16. The method of claim 13, wherein heating the sealed vessel comprises alternating a heating element between on and off states.

17. The method of claim 16, wherein alternating a heating element between on and off states comprises periodically providing electrical current to a resistor coil assembly.

18. The method of claim 13, wherein providing a sealed vessel comprises providing a sealed vessel that contains a solid fuel material and no more than a trace amount of gaseous hydrogen.

19. The method of claim 19, wherein the solid fuel material comprises nickel and hydrogen.

20. The method of claim 13, further comprising:
monitoring a temperature of the sealed vessel; and
wherein heating the sealed vessel comprises selectively heating the sealed vessel in response to the monitored temperature.

21. A system for converting thermal input and fuel into a heat output, comprising:
a device that includes:
a sealed vessel defining an interior;
a heating element proximal the vessel and being selectively activatable to provide heat to the sealed vessel,
a fuel material within the interior of the vessel that comprises a solid including nickel and hydrogen, and wherein the interior of the sealed vessel is not preloaded with a pressurized gas when in an initial operating state before activation of the heating element;
a temperature measuring gauge in communication with the device and configured for monitoring the temperature thereof; and
a controller in communication with the heating element and the temperature measuring gauge, the controller configured to activate the heating element in response to measurements from the temperature measuring gauge.

22. The system of claim 21, wherein the sealed vessel contains no more than a trace amount of gaseous hydrogen.

23. The system of claim 21, wherein the sealed vessel is sealed against gas ingress or egress.

24. The system of claim 21, further comprising a first ceramic shell between the sealed vessel and the heating element.

25. The system of claim 23, further comprising a second ceramic shell surrounding the first ceramic shell and the heating element.

26. The system of claim 21, wherein the sealed vessel consists of steel.

27. The system of claim 21, wherein the sealed vessel comprises a steel tube having two ends sealed by steel caps.

28. The system of claim 21, wherein the interior of the sealed vessel is cylindrical, and wherein the fuel material is uniformly distributed within the interior of the sealed vessel.

29. The system of claim 21, wherein the heating element surrounds the sealed vessel.

30. The system of claim 21, further comprising a first ceramic shell surrounding the sealed vessel and surrounded by the heating element.

31. The system of claim 30, further comprising a second ceramic shell surrounding the heating element.

32. The system of claim 21, wherein the heating element comprises a resistor coil assembly.

33. The system of claim 32, wherein the heating element comprises at least three resistor coils that are disposed of parallel to and equidistant from a center axis of the device.
